(19) United States
(12) Patent Application Publication
(10) Pub. No.: US 2011/0202864 A1
(43) Pub. Date: Aug. 18, 2011

(54) APPARATUS AND METHODS OF RECEIVING AND ACTING ON USER-ENTERED INFORMATION

(76) Inventors: Michael B. Hirsch, San Diego, CA (US); Samuel J. Horodezky, San Diego, CA (US); Ryan R. Rowe, Portola Valley, CA (US); Rainer Wessler, Shanghai (CN); Leo Chen, Shanghai (CN)

(21) Appl. No.: 12/964,505

(22) Filed: Dec. 9, 2010

Related U.S. Application Data
(60) Provisional application No. 61/304,754, filed on Feb. 15, 2010.

(51) Int. Cl. G06F 3/048

(52) U.S. Cl. 715/773; 715/780

(57) ABSTRACT

Apparatus and methods of capturing user-entered information on a device comprise receiving a trigger event to invoke a note-taking application, and displaying, in response to the trigger event, a note display area and one or more action identifiers of the note-taking application on at least a portion of an output display on the device. Also, the apparatus and methods may include receiving an input of information, and displaying the information in the note display area in response to the input. Further, the apparatus and methods may include receiving identification of a selected one of the one or more action identifiers after receiving the input of the information, wherein each of the one or more action identifiers corresponds to a respective action to take with the information. Additionally, the apparatus and methods may include performing an action on the information based on the selected action identifier.

### CLAIM OF PRIORITY UNDER 35 U.S.C. §119

The present Application for Patent claims priority to Provisional Application No. 61/304,754 entitled “APPARATUS AND METHODS OF RECEIVING AND ACTING ON USER-ENTERED INFORMATION” filed Feb. 15, 2010, which is assigned to the assignee hereof and hereby expressly incorporated by reference herein.

### BACKGROUND

1. Field

The described aspects relate to computer devices, and more particularly, to apparatus and methods of receiving and acting on user-entered information.

2. Background

Individuals often have the need to quickly and easily capture information, such as by writing a note on a piece of paper. Some current computer devices provide electronic solutions, such as a voice memo application or a note-taking application. Outside of receiving and storing information, however, applications such as the voice memo application and the note-taking application have virtually no other functionality.

Other applications, such as a short messaging service (SMS), receive information and provide application-specific functionality, such as transmitting the information as a text message. The usefulness of these applications is limited, however, due to their application-specific functionality.

Additionally, besides the above drawbacks, many current electronic solutions provide a less than satisfactory user experience by requiring a user to perform a number of actions before presenting a user interface that can accept user-input information.

Thus, users of computer devices desire improvements in information-receiving devices and applications.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect, a method of capturing user-entered information on a device comprises receiving a trigger event to invoke a note-taking application. Further, the method may include displaying, in response to the trigger event, a note display area and one or more action identifiers of the note-taking application on at least a portion of an output display on the device. Also, the method may include receiving an input of information, and displaying the information in the note display area in response to the input. Further, the method may include receiving identification of a selected one of the one or more action identifiers after receiving the input of the information, wherein each of the one or more action identifiers corresponds to a respective action to take with the information. Additionally, the method may include performing an action on the information based on the selected action identifier.

In another aspect, at least one processor for capturing user-entered information on a device includes a first module for receiving a trigger event to invoke a note-taking application. Further, the at least one processor includes a second hardware module for displaying, in response to the trigger event, a note display area and one or more action identifiers of the note-taking application on at least a portion of an output display on the device. Also, the at least one processor includes a third module for receiving an input of information. The second hardware module is further configured for displaying the information in the note display area in response to the input, and the third module is further configured for receiving identification of a selected one of the one or more action identifiers after receiving the input of the information, wherein each of the one or more action identifiers corresponds to a respective action to take with the information. Additionally, the at least one processor includes a fourth module for performing an action on the information based on the selected action identifier.

In a further aspect, a computer program product for capturing user-entered information on a device includes a non-transitory computer-readable medium having a plurality of instructions. The plurality of instructions include at least one instruction executable by a computer for receiving a trigger event to invoke a note-taking application, and at least one instruction executable by the computer for displaying, in response to the trigger event, a note display area and one or more action identifiers of the note-taking application on at least a portion of an output display on the device. Further, the plurality of instructions include at least one instruction executable by the computer for receiving an input of information, and at least one instruction executable by the computer for displaying the information in the note display area in response to the input. Also, the plurality of instructions include at least one instruction executable by the computer for receiving identification of a selected one of the one or more action identifiers after receiving the input of the information, wherein each of the one or more action identifiers corresponds to a respective action to take with the information. Additionally, the plurality of instructions include at least one instruction executable by the computer for performing an action on the information based on the selected action identifier.

In another aspect, a device for capturing user-entered information, includes means for receiving a trigger event to invoke a note-taking application, and means for displaying, in response to the trigger event, a note display area and one or more action identifiers of the note-taking application on at least a portion of an output display on the means for displaying. Further, the device includes means for receiving an input of information, and means for displaying the information in the note display area in response to the input. Also, the device includes means for receiving identification of a selected one of the one or more action identifiers after receiving the input of the information, wherein each of the one or more action identifiers corresponds to a respective action to take with the information. Additionally, the device includes means for performing an action on the information based on the selected action identifier.

In another aspect, a computer device includes a memory comprising a note-taking application for capturing user-entered information, wherein the note-taking application, and a processor configured to execute the note-taking application. Further, the computer device includes an input mechanism configured to receive a trigger event to invoke a note-taking application, and a display configured to display, in response to the trigger event, a note display area and one or more action identifiers of the note-taking application on at least a portion of an output display on the device. The input mechanism is further configured to receive an input of information, and the display is further configured to display the information in the note display area in response to the input. Also, the input mechanism is further configured to receive identification of a selected one of the one or more action identifiers after receiving the input of the information, wherein each of the one or more action identifiers corresponds to a respective action to take with the information. Additionally, the note-taking application initiates performing an action on the information based on the selected action identifier.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 is a schematic diagram of an aspect of a computer device having an aspect of a note-taking application;

FIG. 2 is a schematic diagram of an aspect of the computer device of FIG. 1, including additional architectural components of the computer device;

FIG. 3 is a schematic diagram of an aspect of a user interface (UI) determiner component;

FIG. 4 is a schematic diagram of an aspect of a pattern matching service component;

FIG. 5 is a flowchart of an aspect of a method of capturing user-entered information on a device, including an optional action in a dashed box;

FIG. 6 is a flowchart of an aspect of an optional addition to the method of FIG. 5;

FIG. 7 is a flowchart of an aspect of an optional addition to method of FIG. 5;

FIG. 8 is a front view of an aspect of an initial window presented by user interface of an aspect of a computer device of FIG. 1 during receipt of a trigger event associated with note-taking application;

FIG. 9 is a front view similar to FIG. 8, including an aspect of displaying a note display area and action identifiers or keys;

FIG. 10 is a front view similar to FIG. 9, including an aspect of displaying of information received via a user-input;

FIG. 11 is a front view similar to FIG. 10, including an aspect of displaying a changed set of action identifiers or keys based on a pattern detected in the information and receiving a selection of an action to perform;

FIG. 12 is a front view similar to FIG. 8, including an aspect of returning to the initial window after performing the action, and an aspect of displaying a confirmation message associated with performing the selected action;

FIGS. 13-20 are front views of user interfaces in an aspect of searching for and viewing a list of notes associated with the note-taking application of FIG. 1;

FIGS. 21-28 are front views of a series of user interfaces in an aspect of capturing and saving a phone number associated with the note-taking application of FIG. 1;

FIGS. 29-36 are front views of a series of user interfaces in an aspect of capturing and saving a geo-tag associated with the note-taking application of FIG. 1;

FIGS. 37-40 are front views of a series of user interfaces in an aspect of capturing and saving a web page link associated with the note-taking application of FIG. 1;

FIGS. 41-44 are front views of a series of user interfaces in an aspect of capturing and saving an email address associated with the note-taking application of FIG. 1;

FIGS. 45-48 are front views of a series of user interfaces in an aspect of capturing and saving a date associated with the note-taking application of FIG. 1;

FIGS. 49-52 are front views of a series of user interfaces in an aspect of capturing and saving a contact associated with the note-taking application of FIG. 1;

FIGS. 53-56 are front views of a series of user interfaces in an aspect of capturing and saving a photograph associated with the note-taking application of FIG. 1;

FIGS. 57-64 are front views of a series of user interfaces in an aspect of capturing and saving audio data associated with the note-taking application of FIG. 1; and

FIG. 65 is a schematic diagram of an aspect of an apparatus for capturing user-entered information.

### DETAILED DESCRIPTION

Various aspects are now described with reference to the drawings. In the following description, for purposes of explanation, numerous specific details are set forth in order to provide a thorough understanding of one or more aspects. It should be noted, however, that such aspects may be practiced without these specific details.

The described aspects relate to apparatus and methods of receiving and acting on user-entered information. Specifically, in an aspect, a note-taking application is configured to be invoked quickly and easily on a computer device, for example, to swiftly obtain any user-input information before a user decision is received as to what action to take on the information. In an aspect, without regard to a currently executing application, e.g. in any operational state, the computer device may receive a trigger event, such as a user input to a key or a touch-sensitive display, to invoke the note-taking application and cause a display of a note display area and one or more action identifiers. Each action identifier corresponds to a respective action to take on information input into the note-taking application and displayed in the note display area. For example, each action may correspond to a respective function of one of a plurality of applications on the computer device, such as saving a note in the note-taking application, sending a text message in a short message service application, sending an e-mail in an e-mail application, etc. Optionally, such as on a computer device without a mechanical keypad, the trigger event may further cause a display of a virtual keypad.

Input of information is then received by the mechanical or virtual keypad, and the information is displayed in the note display area. In an aspect, for example, the input information may include, but is not limited to, one or any combination of text, voice or audio, geographic position and/or movement information such as a geo-tag or GPS-like data, video, graphics, photographs, and any other information capable of being received by a computer device. For example, the input information may combine two or more of text information, graphic information, audio/video information, geo-tag information, etc. In an aspect, all or some portion of the input information may be represented in the note display area with an icon, graphic, or identifier, e.g. a thumbnail of a photograph, an icon indicating an audio clip or geo-tag, etc. In other words, in an aspect, the apparatus and methods may display a representation of two or more types of different information.

Optionally, in an aspect, the apparatus and methods may further include a pattern detector that is configured to recognize patterns in the received information. Based on a recognized pattern, the one or more action identifiers may change to include a pattern-matched action identifier.

In an aspect, the displayed action identifiers may vary based on the input information. In an aspect, but not to be construed as limiting, there may be a base set of one or more standard action identifiers that may be common without regard to the input information, and there may be an information-specific set of action identifiers that can be generated in the note display area in response to determining a pattern in the input information. For example, a common action identifier, such as a Save Note function, may provide a function that is likely of interest no matter what information is input. Further, for example, an information-specific action identifier, such as a Save Contact function, may be generated when the input information is detected to likely match contact information, such as a name, address, phone number, etc.

After obtaining the information, an indication of a selected one of the one or more action identifiers or the pattern-matched action identifier is received, and then the respective action is performed on the information.

Once the action is performed, the display of the notepad display area and action identifiers is discontinued.

Optionally, a confirmation message may be displayed to inform a user that the action has been completed.

Thus, the described aspects provide apparatus and methods of quickly and easily invoking a note-taking application, obtaining user-input information before a user decision on an action is received, and then receiving a selected action from a plurality of action identifiers, which may be customized depending on a pattern in the received information.

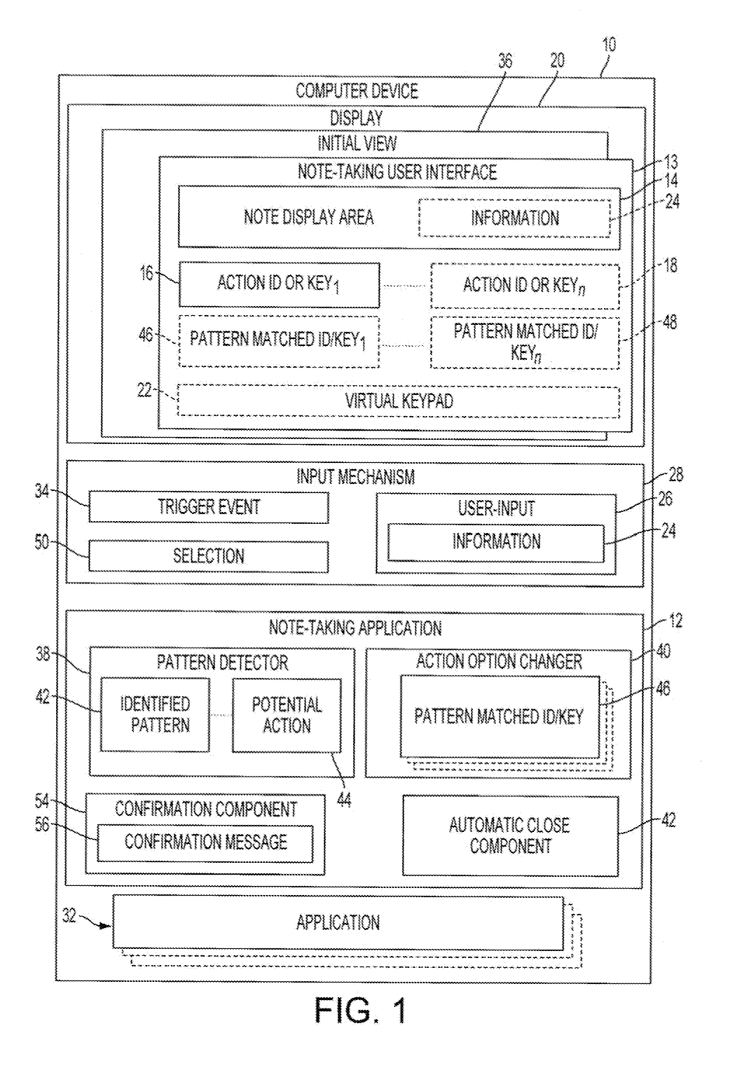

Referring to FIG. 1, in an aspect, a computer device 10 includes a note-taking application 12 operable to receive user information, and then after acquiring the information, providing a user with options as to actions to perform on the information. Note-taking application 12 may include, but is not limited to, instructions that are executable to generate a note-taking user interface 13 on a display 20, where the note-taking user interface 13 includes a note display area 14 for displaying user-inputs and a number, n, of action identifiers or keys 16, 18 that indicate respective actions to be performed on the user-inputs. The number, n, may be any positive integer, e.g. one or more, and may depend on how note-taking application 12 is programmed and/or on the capabilities of computer device 10. Optionally, note-taking application 12 may also include, but is not limited to, instructions that are executable to generate a virtual keypad 22, on display 20, for receiving user-inputs.

More specifically, note display area 14 generally comprises a window that displays information 24, such as but is not limited to text, numbers or characters, which represents a user-input 26 received by an input mechanism 28. For example, information 24 may be a note created by a user of computer device 10, and may include but is not limited to one or more of text information, voice information, audio information, geographic position, or any other type of input receivable by computer device 10. Input mechanism 28 may include, but is not limited to, a keypad, a track ball, a joystick, a motion sensor, a microphone, virtual keypad 22, a voice-to-text translation component, another application on computer device, such as a geographic positioning application or a web browser application, or any other mechanism for receiving inputs representing, for example, text, numbers or characters. As such, input mechanism 28 may include display 20, e.g. a touch-sensitive display, such as note-taking user interface 13, or may be separate from display 20, such as a mechanical keypad.

Each action identifier or key 16, 18 indicates a user-selectable element that corresponds to an action to be performed on information 24. For example, each action identifier or key 16, 18 may be a field with a name or other indicator representing the action and associated with a mechanical key, which may be a part of input mechanism 28, or a virtual key including the name or indicator representing the action, or some combination of both. Further, each action corresponds to a respective function 30 of one of a plurality of applications 32 on computer device 10. For example, the plurality of applications 32 may include, but are not limited to, one or any combination of a short message service (SMS) application, an electronic mail application, a web browser application, a personal information manager application such as one or more of a contacts list or address book application or a calendar application, a multimedia service application, a camera or video recorder application, an instant messaging application, a social networking application, note-taking application 12, or any other type application capable of execution on computer device 10. Correspondingly, function 30 may include, but is not limited to, one or any combination of a save function, a copy function, a paste function, a send e-mail function, a send text message function, a send instant message function, a save bookmark function, an open web browser based on a universal resource locator (URL) function, etc., or any other function capable of being performed by an application on computer device 10. As such, each action identifier or key 16, 18 represents an action corresponding to a respective function 30 of a respective one of the plurality of applications 32.

Additionally, note-taking application 12 may be invoked by a trigger event 34, which may be received at input mechanism 28. For example, trigger event 34 may include, but is not limited to, one or any combination of a depression of a key, a detected contact with a touch-sensitive display, a receipt of audio or voice by a microphone, a detected movement of computer device 10, or any other received input at input mechanism 28 recognized as an initiation of note-taking application 12.

In an aspect, trigger event 34 may invoke note-taking application 12 in any operational state of computer device 10. For example, as computer device 10 may include plurality of applications 32, trigger event 34 may be recognized and may initiate note-taking application 12 during execution of any of the plurality of applications 32. In other words, even without an indication on computer device 10 of the availability of note-taking application 12, e.g. without an icon or link being present in a window on display 20, trigger event 34 may be universally recognized on computer device 10 to invoke note-taking application 12 at any time and from within any running application. As such, the displaying of note-taking user interface 13, including note display area 14 and one or more action identifiers or keys 16, 18, may at least partially overlay an initial window 36 on display 20 corresponding to a currently executing one of the plurality of applications 32 at a time that trigger event 34 is received by input mechanism 28.

Optionally, computer device 10 or note-taking application 12 may include a pattern detector 38 to detect patterns in information 24, and an action option changer 40 to change available ones of the one or more action identifiers or keys 16, 18 depending on an identified pattern 42 in information 24. For example, pattern detector 38 may include, but is not limited to, logic, rules, heuristics, neural networks, etc., to associate all or a portion of information 24 with a potential action to be performed on information 24 based on identified pattern 42. For instance, pattern detector 38 may recognize that information 24 includes identified pattern 42, such as a phone number, and recognize that a potential action 44 may be to save a record in a contact list. Further, other examples of identified pattern 42 and potential action 44 include, but are not limited to, recognizing a URL or web address and identifying saving a bookmark or opening a web page as potential actions; and recognizing a text entry and identifying sending a text message or an e-mail, or saving a note or contact information, as potential options. In other words, in an aspect, pattern detector 38 may analyze information 24, determine identified pattern 42 in information 24, and determine potential action 44 corresponding to a respective function 30 of one or more of the plurality of applications 32, or more generally determine one or more of the plurality of applications 32, that may be relevant to information 24 based on identified pattern 42.

Based on the results produced by pattern detector 38, action option changer 40 may change the one or more action identifiers or keys 16, 18 to include a number, n, of one or more pattern-matched action identifiers or keys 46, 48 on display 20. For example, in an aspect, upon invocation of note-taking application 12, a first set of one or more action identifiers or keys 16, 18 may include a default set, while a second set of one or more action identifiers or keys 16, 18 and one or more pattern-matched action identifiers or keys 46, 48 may include a different set of actions based on identified pattern 42 in information 24. The second set may include, for example, all of the first set, none of the first set, or some of the first set.

In any case, after receiving information 24, note-taking application 12 may initiate an action on information 24 in response to a selection 50 indicating a corresponding selected one of the one or more action identifiers or keys 16, 18, or the one or more pattern-matched action identifiers or keys 46, 48. For example, selection 50 may be received by input mechanism 28, or by a respective action identifier or key 16, 18, 46, 48, or some combination of both. As noted above, the action initiated by note-taking application 12 may correspond to a respective function 30 of one of the plurality of applications 32 on computer device 10. As such, note-taking application 12 may integrate or link to one or more of the plurality of applications 32, or more specifically integrate or link to one or more functions 30 of one or more of the plurality of applications 32. Accordingly, based on identified pattern 42 within information 24, pattern detector 38 and action option changer 40 may operate to customize potential actions to be taken on information 24.

Optionally, in an aspect, computer device 10 or note-taking application 12 may further include an automatic close component 52 configured to stop the displaying of note display area 14 and action identifiers or keys 16, 18, 46, 48, or virtual keypad 22, in response to performance of the respective action corresponding to selection 50. Further, for example, automatic close component 52 may initiate the shutting down or closing of note-taking application 12 after the performing of the respective action.

In another optional aspect, computer device 10 or note-taking application 12 may further include a confirmation component 54 to display a confirmation message 56 that indicates whether or not the selected action or function has been performed on information 24. As such, confirmation message 56 alerts the user of computer device 10 that the requested action has been performed, or if some problem was encountered that prohibited performance of the action. For example, confirmation component 54 may initiate generation of confirmation message 56 for displaying for a time period, such as for a time period determined to provide a user with enough time to notice the alert. In an aspect, confirmation component 54 may send a signal to automatic close component 52 to initiate the cessation of displaying of note display area 14 and action identifiers or keys 16, 18, 46, 48, or virtual keypad 22, in response to performance of the respective action, thereby allowing confirmation message 56 to be more noticeable on display 20. Further, in an aspect, confirmation component 54 may indicate to automatic close component 52 a completion of the presentation of confirmation message 56, or may communicate the time period of displaying confirmation message 56, to allow automatic close component 52 to continue with the shutting down of note-taking application 12.

Thus, note-taking application 12 provides a user with a quickly and easily invoked note display area 14 to capture information 24 from within any operational state of computer device 10, and once information 24 is captured, a plethora of options, across multiple applications and functions and including actions customized to identified patterns 42 in information 24, as to how to act on information 24. Moreover, note-taking application 12 initiates an action on information 24 in response to a selection 50 indicating a corresponding selected one of the one or more action identifiers or keys 16, 18, or the one or more pattern-matched action identifiers or keys 46, 48.

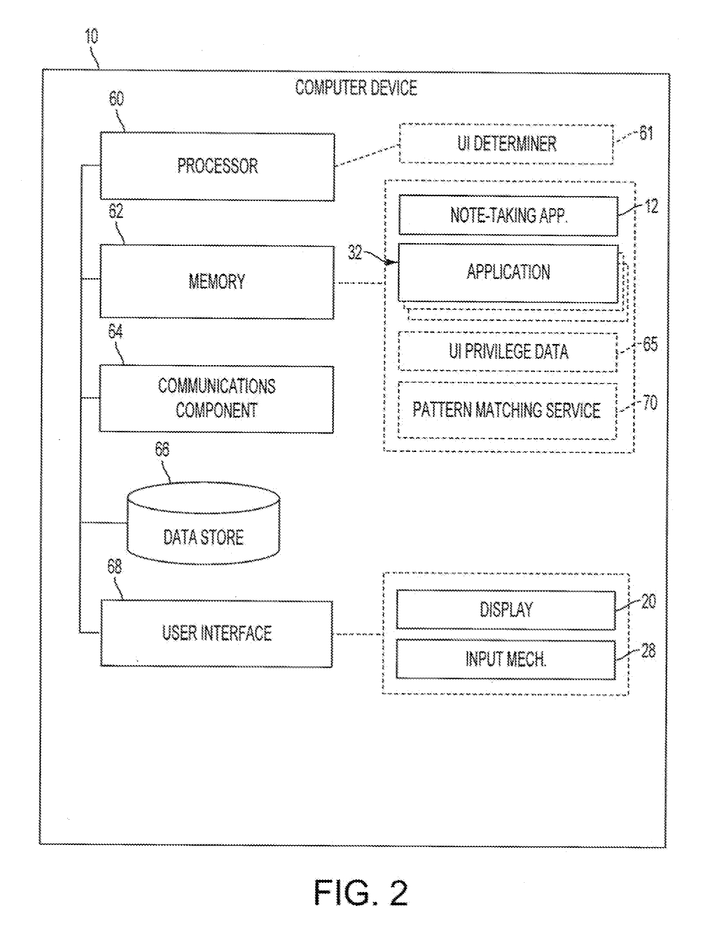

Referring to FIG. 2, in one aspect, computer device 10 may include a processor 60 for carrying out processing functions, e.g. executing computer readable instructions, associated with one or more of components, applications, and/or functions described herein. Processor 60 can include a single or multiple set of processors or multi-core processors, and may include one or more processor modules corresponding to each function described herein. Moreover, processor 60 can be implemented as an integrated processing system and/or a distributed processing system.

Computer device 10 may further include a memory 62, such as for storing data and/or local versions of applications being executed by processor 60. Memory 62 can include any type of memory usable by a computer, such as random access memory (RAM), read only memory (ROM), tapes, magnetic discs, optical discs, volatile memory, non-volatile memory, and any combination thereof. For instance, memory 62 may store executing copies off one or more of the plurality of applications 32, including note-taking application 12, pattern detector 38, action option changer 40, automatic close component 52, or confirmation component 54.

Further, computer device 10 may include a communications component 64 that provides for establishing and maintaining communications with one or more parties utilizing hardware, software, and services as described herein. Communications component 64 may carry communications between components on computer device 10, as well as between computer device 10 and external devices, such as devices located across a communications network and/or devices serially or locally connected to computer device 10. For example, communications component 64 may include one or more interfaces and buses, and may further include transmitter components and receiver components operable for wired or wireless communications with external devices.

Additionally, computer device 10 may further include a data store 66, which can be any suitable combination of hardware and/or software, that provides for mass storage of information, databases, and programs employed in connection with aspects described herein. For example, data store 66 may be a memory or data repository for applications not currently being executed by processor 60. For instance, data store 66 may store one or more of plurality of applications 28, including note-taking application 12, pattern detector 38, action option changer 40, automatic close component 52, or confirmation component 54.

Computer device 10 may additionally include a user interface component 68 operable to receive inputs from a user of computer device 10, and further operable to generate outputs for presentation to the user. User interface component 68 may include one or more input devices, including but not limited to a keyboard, a number pad, a mouse, a touch-sensitive display, a navigation key, a function key, a microphone, a voice recognition component, input mechanism 28, action identifiers or keys 16, 18, 46, 48, virtual keypad 22, or any other mechanism capable of receiving an input from a user, or any combination thereof. Further, user interface component 68 may include one or more output devices, including but not limited to display 20, a speaker, a haptic feedback mechanism, a printer, or any other mechanism capable of presenting an output to a user, or any combination thereof.

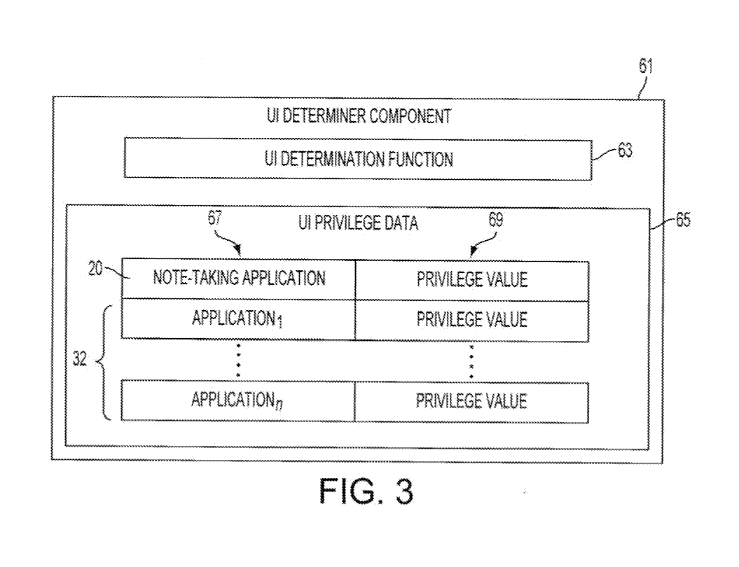

Referring to FIGS. 2 and 3, in an optional aspect, computer device 10 may additionally include a user interface (UI) determiner component 61 that assists in allowing note-taking application 12 to be available from any user interface on computer device 10. For example, UI determiner component 61 may include a UI determination function 63 that governs what is drawn on display 20 (FIG. 1). For instance, in response to an invoking event, such as a user input to launch note-taking application 12, UI determination function 63 may allow note-taking user interface 13 (FIG. 1), such as a window, to be drawn on display 20 (FIG. 1) to partially or completely overlay initial window 36 (FIG. 1), e.g. the existing user interface associated with an executing one of applications 32. In an aspect, UI determiner component 61 and/or UI determination function 63 may access UI privilege data 65 to determine how to draw user interfaces on display 20 (FIG. 1). For example, UI privilege data 65 may include application identifications 67 associated with corresponding UI privilege values 69, where note-taking application 20 may have a relatively high or highest privilege relative to other applications 32 on computer device 10. In an aspect, for example, UI privilege data 65 may be determined by a manufacturer of computer device 10 or by an operator, e.g. a wireless network service provider, associated with the network on which computer device 10 is subscribed for communications. Thus, UI determiner component 61 enables note-taking user interface 13 to be elevated on display 20 (FIG. 1), assisting in making note-taking application 12 available from anywhere on computer device 10.

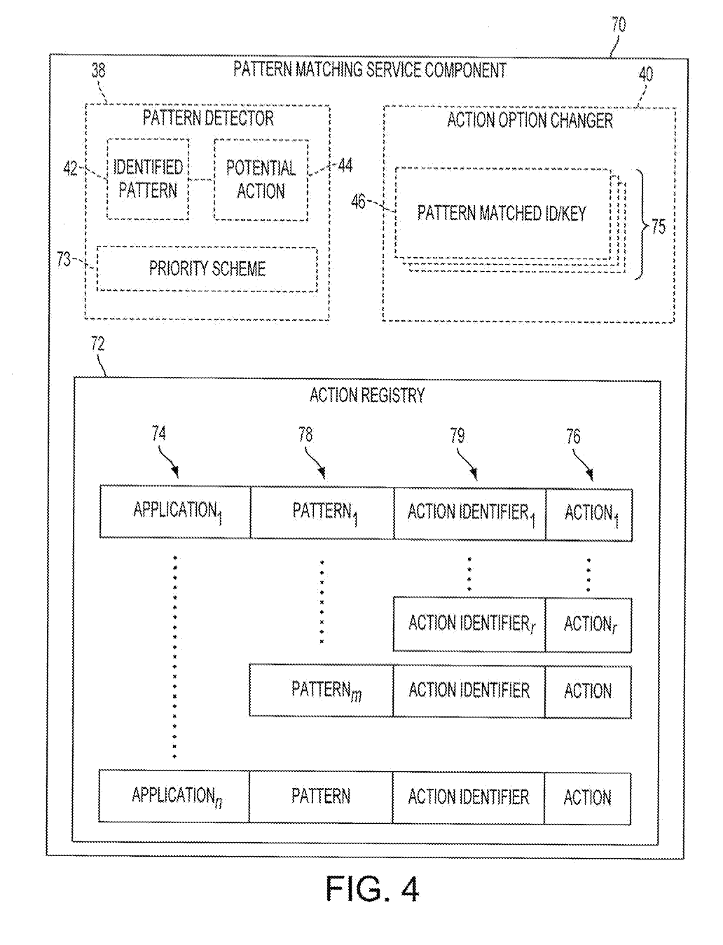

Referring to FIGS. 2 and 4, in an optional aspect, computer device 10 may include a pattern matching service component 70 that includes, or has access to, an action registry 72 where one or more applications 74 may register one or more actions 76 to be associated with one or more patterns 78, such as identified pattern 42 (FIG. 1). Each action 76, which may include the previously discussed potential action 44 (FIG. 1), may correspond to an action identifier 79, such as the previously discussed action ID or key 18 (FIG. 1) and pattern matched IDs or keys 46 and 48 (FIG. 1). Further, for example, the previously-discussed pattern detector 38 and action option changer 40 may be a part of, or associated with, pattern matching service component 70.

In any case, action registry 72, which may be a separate, centralized component, maintains a list of actions 76, such as actions 1 to r, wherein r is a positive integer, associated with specific patterns 78, such as patterns 1 to m, where m is a positive integer, e.g. such as one or more identified pattern 42 (FIG. 1). For example, in an aspect, patterns 78 may include, but are not limited to, a universal resource locator (URL), an email address, a physical or mailing address, a phone number, a date, a name, a Multipurpose Internet Mail Extension (MIME) type, or any other identifiable arrangement of text, graphics, symbols, etc. Additionally, action registry 72 allows one or more applications 74, e.g. applications 1 to n, where n is a positive integer, including applications such as note-taking application 12 or any other one of the plurality of applications 32 associated with computer device 10, to register new actions 76 and patterns 78. In an aspect, upon initialization action registry 72 may include a base set of actions and corresponding patterns, such as a subset of the list of actions 76 and a subset of identified patterns 78, respectively, that may be available for selection by each application 74. Moreover, action registry 72 may allow each application 74 to remove one or more actions 76 and/or one or more identified patterns 78 associated with the respective application. In another aspect, action registry 72 may delete the relationship between a respective application 74, identified patterns 78, actions identifiers 79 and actions 76 upon deletion of the respective application 74 from a memory, such as memory 62 or data store 66 (FIG. 2), of computer device 10.

For instance, in an aspect, when pattern matching service 70 or pattern detector 38 identifies a matched URL, then the corresponding action 76 or action identifier 79 may be, but is not limited to, one or more of copy, open, bookmark, or share the URL via another application, such as a text messaging, email, or social networking application. Further, for example, in an aspect, when pattern matching service 70 or pattern detector 38 identifies a matched email address, then the corresponding action 76 or action identifier 79 may be, but is not limited to, one or more of copy, compose email to the email address, add to existing contacts, create a new contact, or share the email address via another application, such as a text messaging, email, or social networking application. Also, for example, when pattern matching service 70 or pattern detector 38 identifies a matched physical or mailing address, then the corresponding action 76 or action identifier 79 may be, but is not limited to, one or more of copy, map, add to existing contact, create new contact, share location via another application, such as a text messaging, email, or social networking application. Further, for example, when pattern matching service 70 or pattern detector 38 identifies a matched phone number, then the corresponding action 76 or action identifier 79 may be, but is not limited to, one or more of copy, call, compose text or multimedia message, compose social networking message, add to existing contact, or create new contact. Additionally, for example, when pattern matching service 70 or pattern detector 38 identifies a matched date, then the corresponding action 76 or action identifier 79 may be, but is not limited to, one or more of copy, create calendar event, or go to the date in a calendar application. If a date is identified without a year, pattern matching service 70 or pattern detector 38 may be configured to assume to use the next instance of that date, e.g. the current year unless the date has passed, in which case assume the next year. Moreover, for example, when pattern matching service 70 or pattern detector 38 identifies a matched name, e.g. a name contained in a personal information manager, contacts or address book application, then the corresponding action 76 or action identifier 79 may be, but is not limited to, one or more of copy, call including an option as to which number if more than one number is associated with the identified name, compose and send a message, such as an email, text message, multimedia message, social network message, etc. to the name, including an option as to which destination (e.g. email address, phone number, etc.) if more than one destination is associated with the identified name, or open record corresponding to the name in the respective personal information manager, contacts or address book application.

With regard to note-taking application 12, pattern matching service 70 or pattern detector 38 is triggered upon receiving information 24 (FIG. 1) in note-taking area 14 (FIG. 1), and scans information 24 to determine if any portion of information 24 matches one or more of the registered patterns 78. If so, then pattern matching service 70 or pattern detector 38 recognizes the respective one of the patterns 78, e.g. identified pattern 42, and the corresponding action 76 and/or action identifier 79, e.g. potential action 44. Subsequently, the identified matching pattern triggers action option changer 40 to generate one or more pattern matched identifiers or keys, e.g. pattern matched keys 46 and 48, on the note-taking user interface 13 (FIG. 1). Pattern matching service 70 or pattern detector 38 may work similarly for other applications resident on computer device 10, e.g. one or more of applications 32 (FIG. 1).

Optionally, when more than one matching pattern 78 is identified, e.g. in information 24 in note display area 14 (FIG. 1), then pattern matching service 70 or pattern detector 38 or action option changer 40 may include a priority scheme 73 for presenting all or a portion of the pattern matched identifiers or keys, e.g. identifiers or keys 46 or 48, in a particular order 75. For example, priority scheme 73 may rank each pattern 78, such that the particular order 75 includes initially presenting actions 76 or action identifiers 79 or the corresponding keys 46 or 48 corresponding to the highest ranking pattern 78, e.g. with other actions/identifiers corresponding to other matched patterns being presentable on subsequent windows, or with presenting at a top of an ordered list.

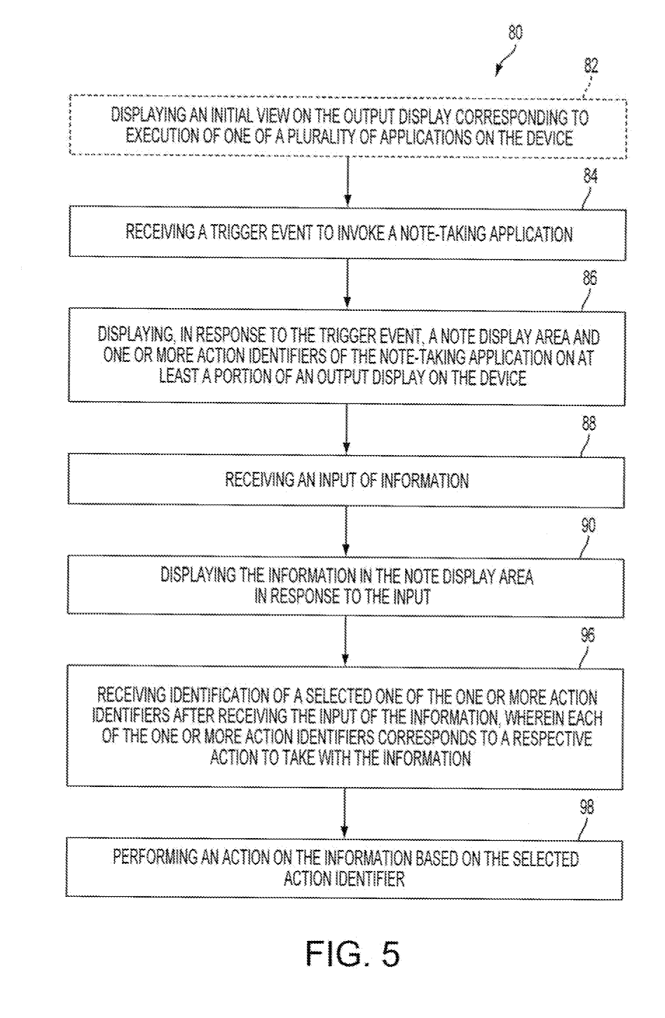

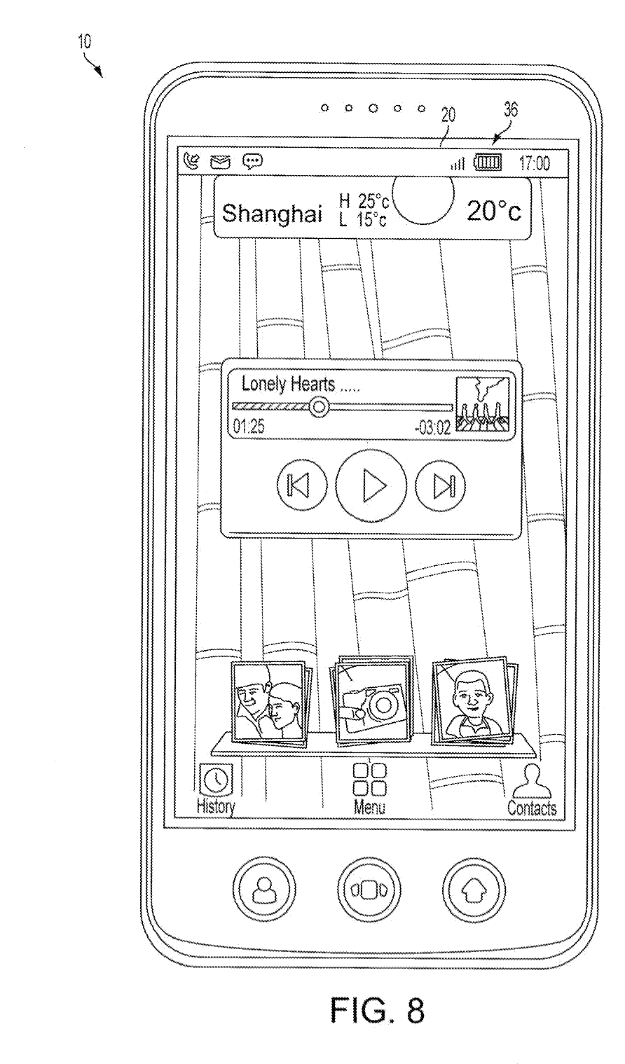

Referring to FIGS. 5-12, a method 80 (FIGS. 5-7) of operation of an aspect of note-taking application on an aspect of a computer device 10 (FIGS. 8-12) includes a number of operations. For example, referring to FIG. 5, block 84, the method includes receiving a trigger event 34 (FIG. 8) to invoke a note-taking application.

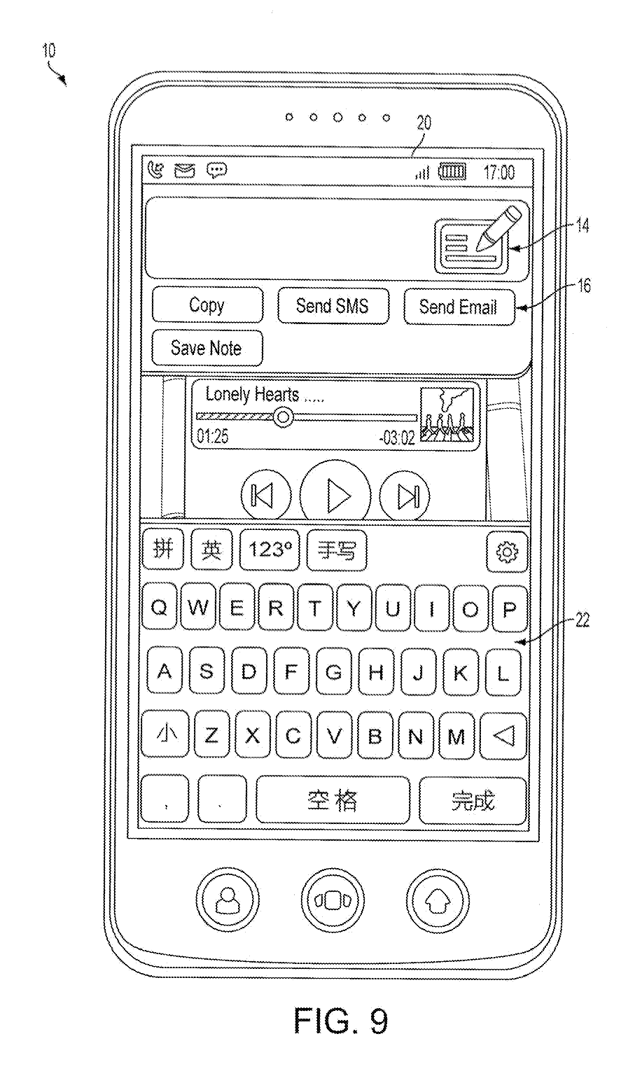

Further, referring to FIG. 5, block 86, the method includes displaying, in response to the trigger event, a note display area 14 (FIG. 9) and one or more action identifiers 16 (FIG. 9) of the note-taking application on at least a portion of an output display 20 (FIG. 9) on the device. Optionally, the displaying in response to the trigger event may further include a virtual keypad 22 (FIG. 9) for receiving user inputs.

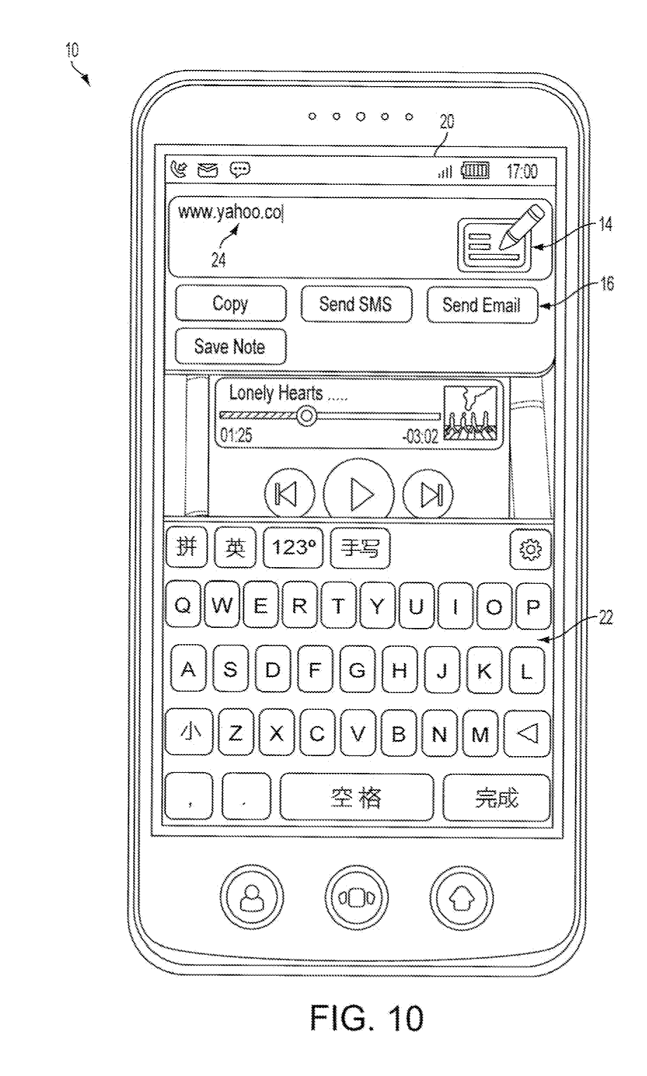

Additionally, referring to FIG. 5, blocks 88 and 90, the method includes receiving an input of information and displaying the information 24 (FIG. 10) in the note display area 14 (FIG. 10) in response to the input;

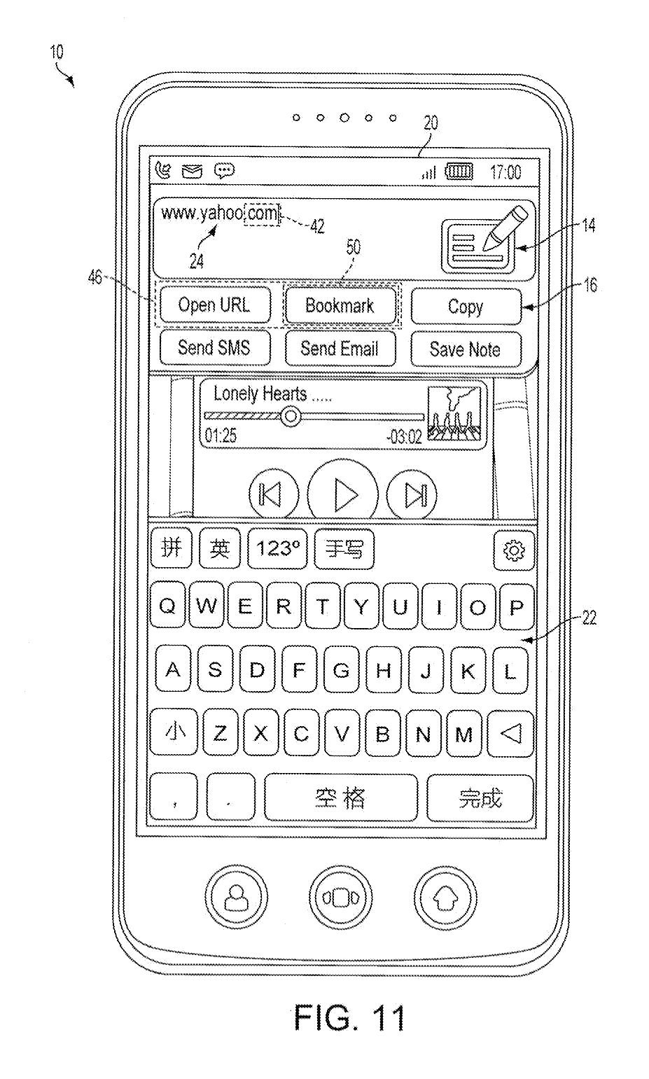

Also, referring to FIG. 5, block 96, the method includes receiving a selection 50 (FIG. 11) identifying a selected one of the one or more action identifiers 16 (FIG. 11) after receiving the input of the information 24 (FIG. 11), wherein each of the one or more action identifiers corresponds to a respective action to take with the information.

Moreover, referring to FIG. 5, block 98, the method includes performing an action on the information based on the selected action identifier. For example, in an aspect, performing the action further comprises executing the one of the plurality of applications corresponding to the selected action identifier to perform the respective function.

Optionally, in an aspect, referring to FIG. 5, block 82, prior to receiving the trigger event (Block 84), the method may include displaying an initial window 36 (FIG. 8) on the output display 20 (FIG. 8) corresponding to execution of one of a plurality of applications on the device.

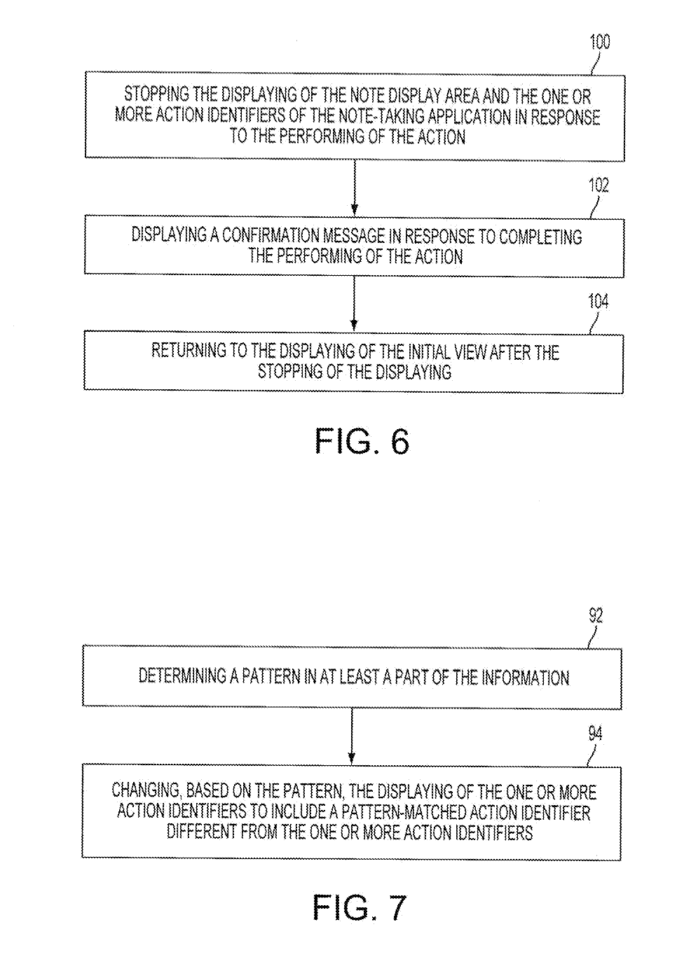

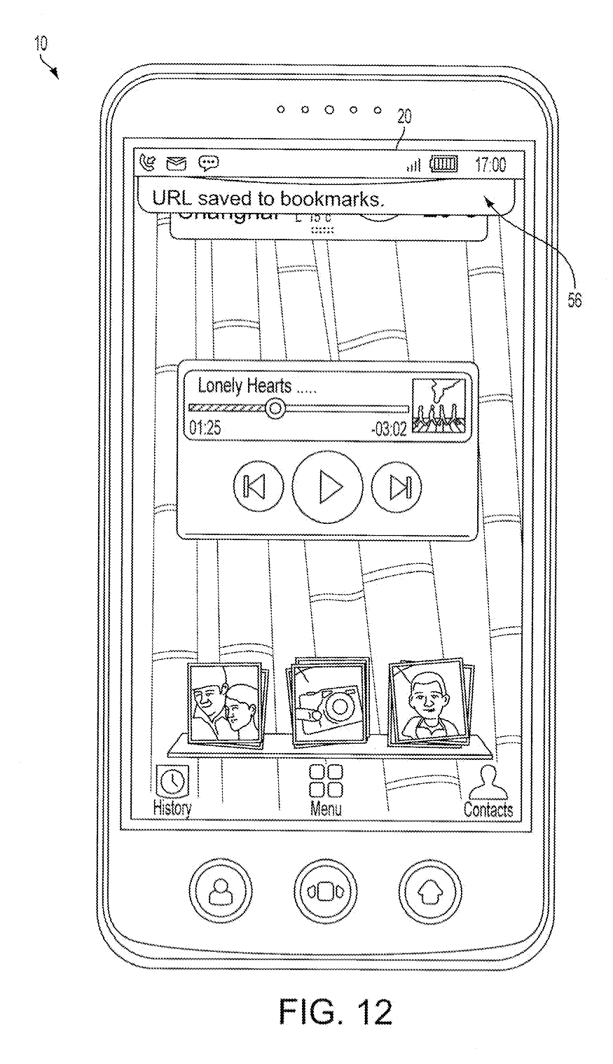

In further optional aspects, referring to FIG. 6, blocks 100, 102 and 104, and FIG. 12, after performing the action (FIG. 5, Block 98), the method may further include one or more of stopping the displaying of the note display area and the one or more action identifiers of the note-taking application in response to the performing of the action (Block 100), displaying a confirmation message 56 (FIG. 12) in response to completing the performing of the action, or returning to the displaying of the initial window 36 (FIG. 12) after stopping the displaying of the note display area and the one or more action identifiers.

In a further additional optional aspect, referring to FIG. 7, during the receiving of the information (FIG. 5, Block 88) or prior to receiving a selection of an action (FIG. 5, Block 96), the method may also include, at Block 92, determining a pattern 42 (FIG. 11) in at least a part of the information, and, at Block 94, changing, based on the pattern, the displaying of the one or more action identifiers to include one or more pattern-matched action identifiers 46 (FIG. 11) different from the initial set of one or more action identifiers 16 (FIG. 11).

It should be noted that the above-mentioned optional aspects may be combined together in any fashion with the other actions of method 80 (FIGS. 5-7).

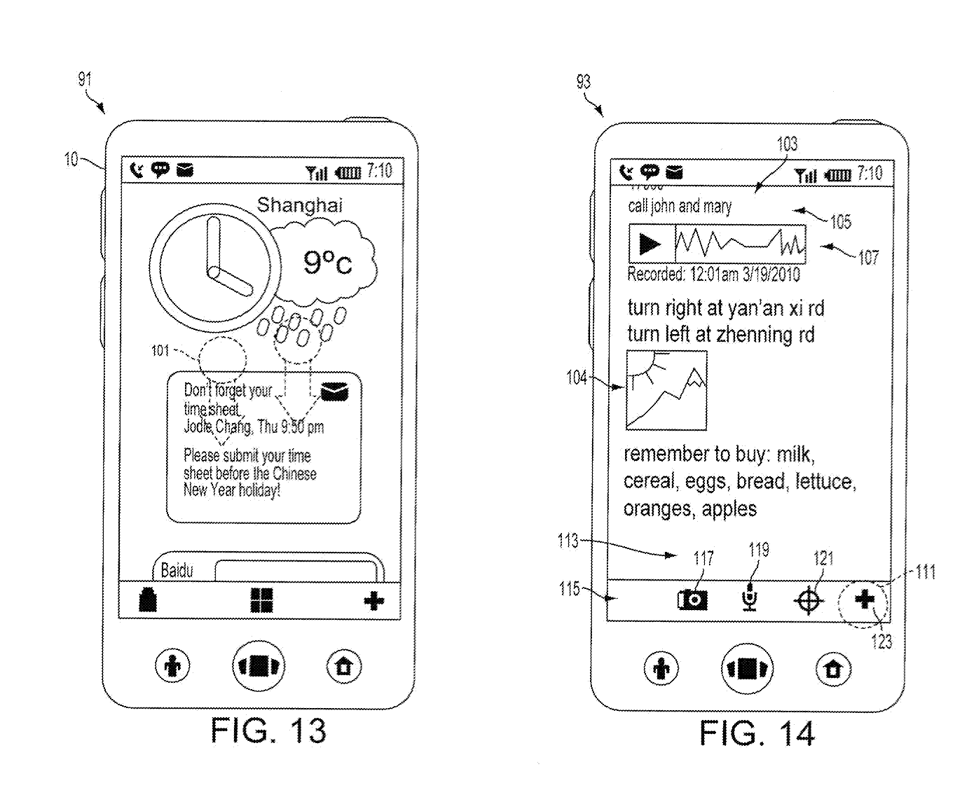

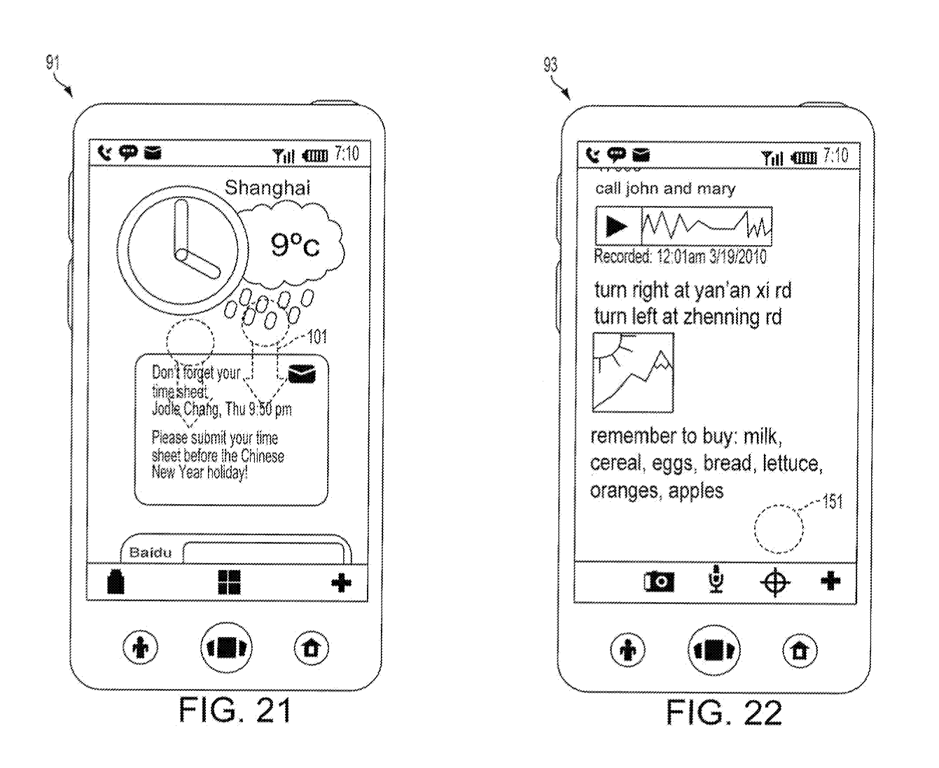

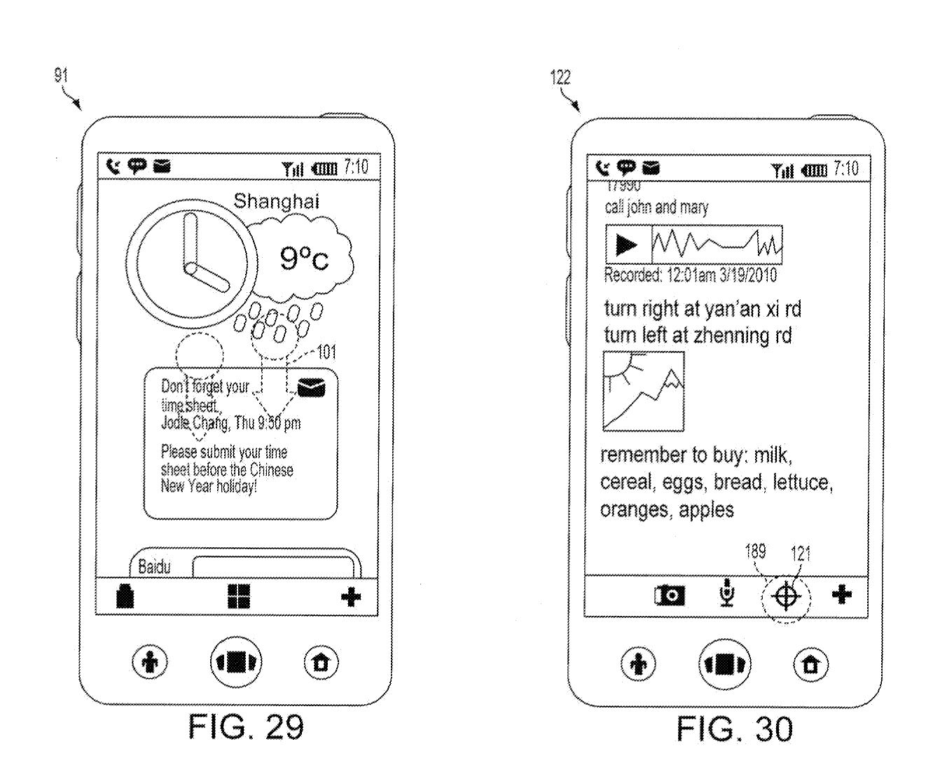

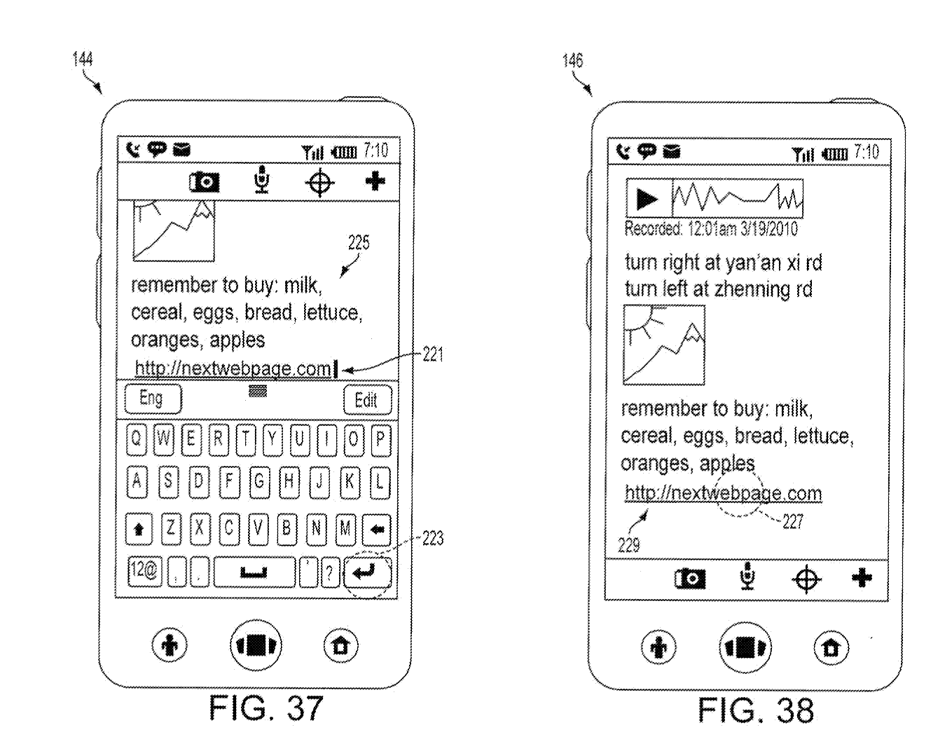

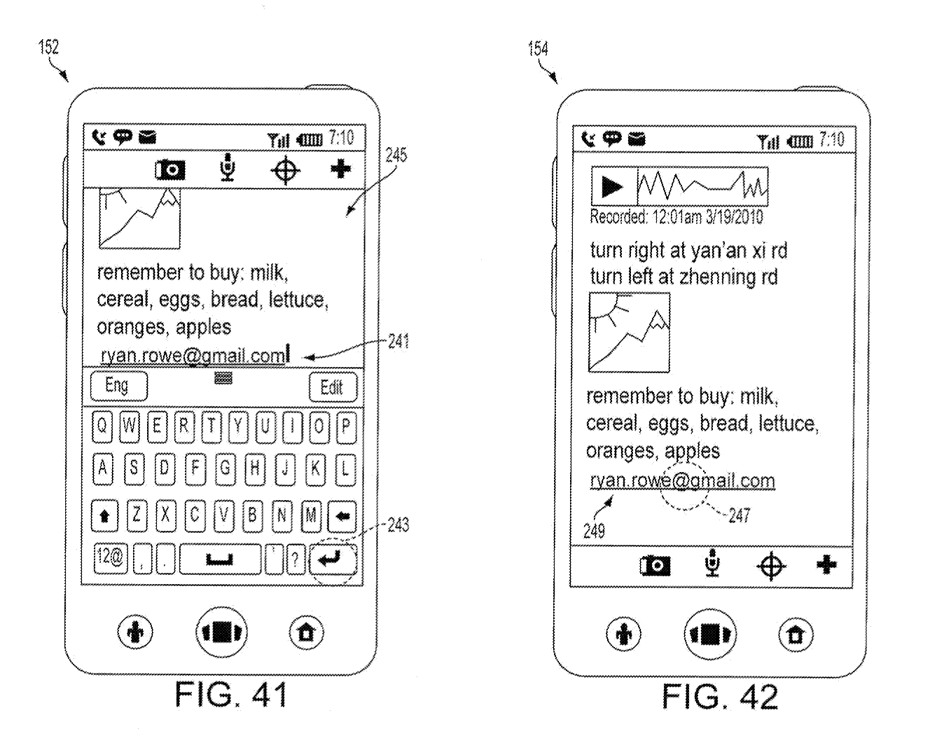

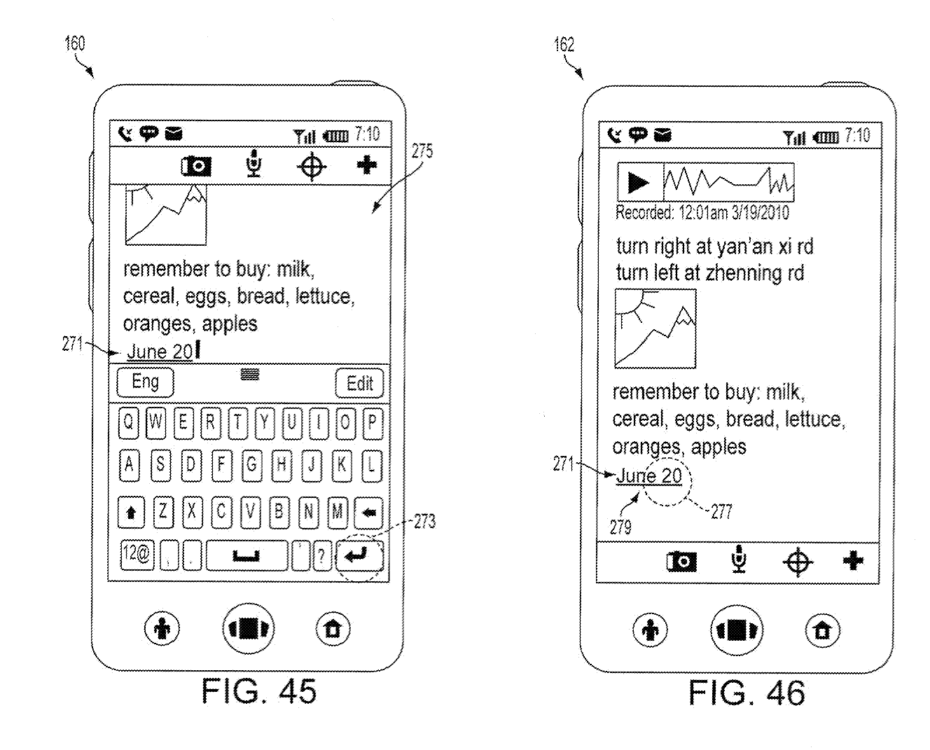

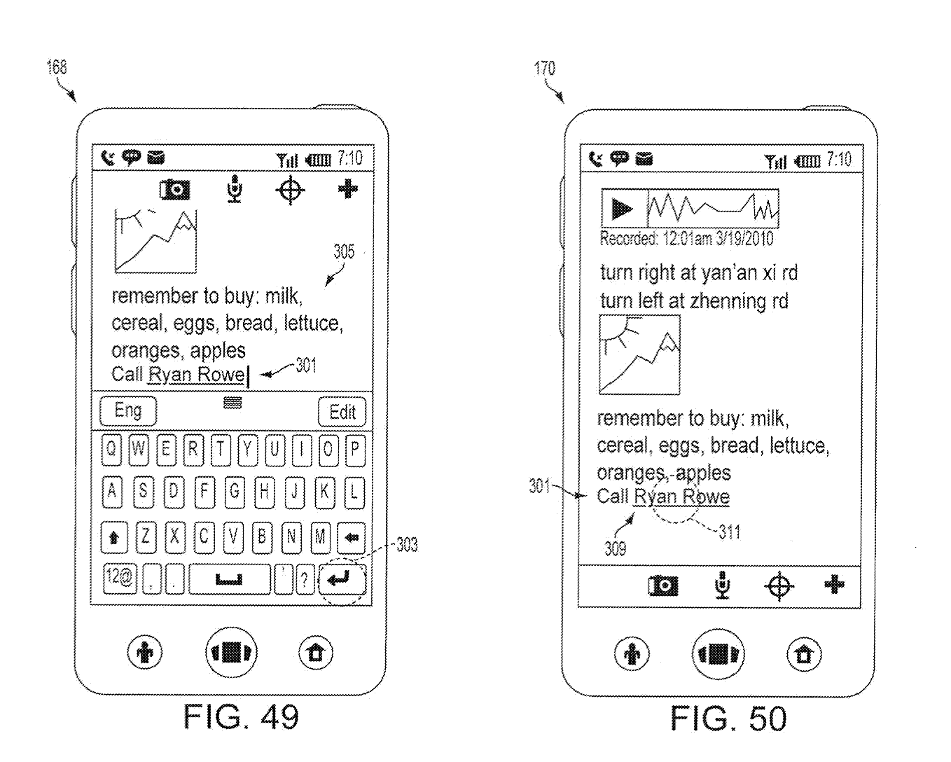

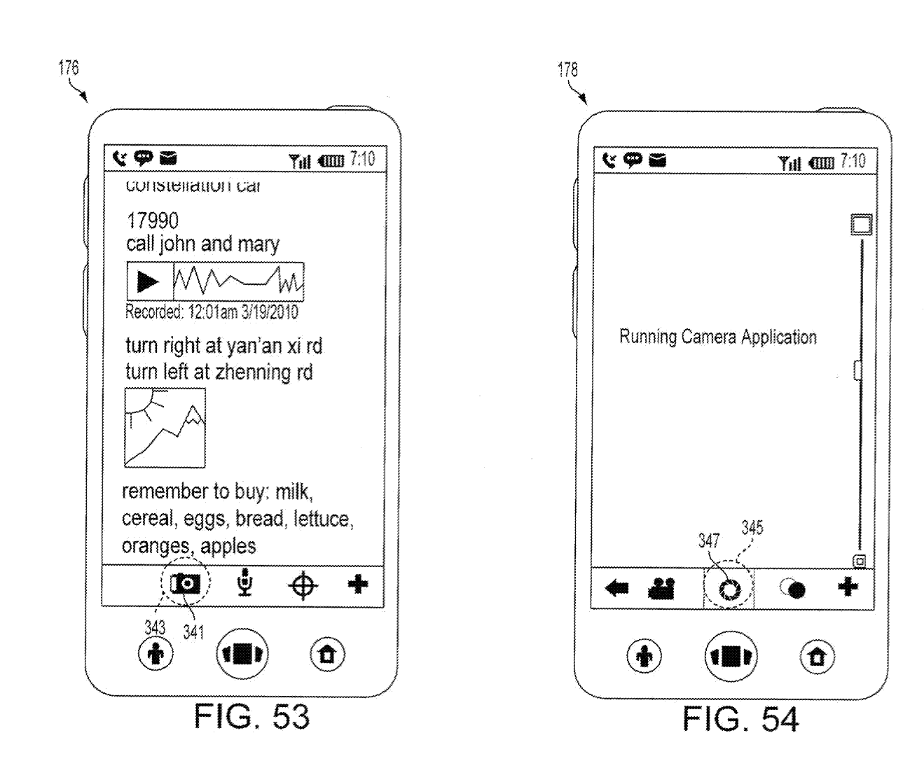

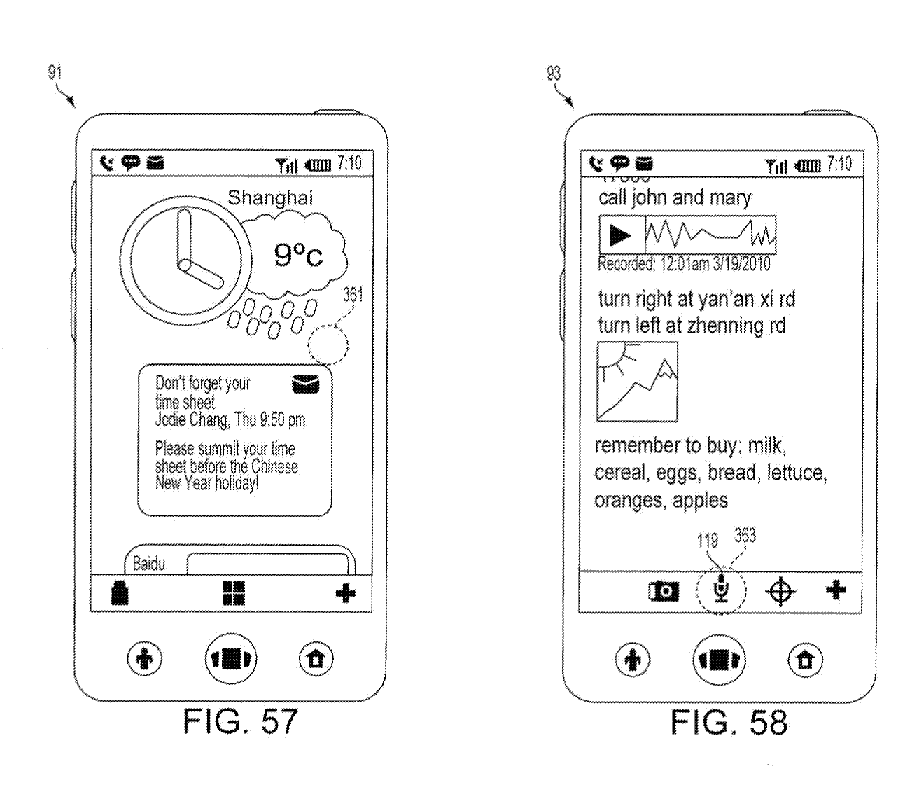

Referring to FIGS. 13-64, in one aspect, examples of a series of user interfaces associated with operation of note-taking application 12 on computer device 10 include: searching for and viewing a list of notes (FIGS. 13-20); capturing and saving a phone number (FIGS. 21-28); capturing and saving a geo-tag (FIGS. 29-36); capturing and saving a web page link (FIGS. 37-40); capturing and saving an email address (FIGS. 41-44); capturing and saving a date (FIGS. 45-48); capturing and saving a contact (FIGS. 49-52); capturing and saving a photograph (FIGS. 53-56); and capturing and saving audio data (FIGS. 57-64). It should be understood that these examples are not to be construed as limiting.

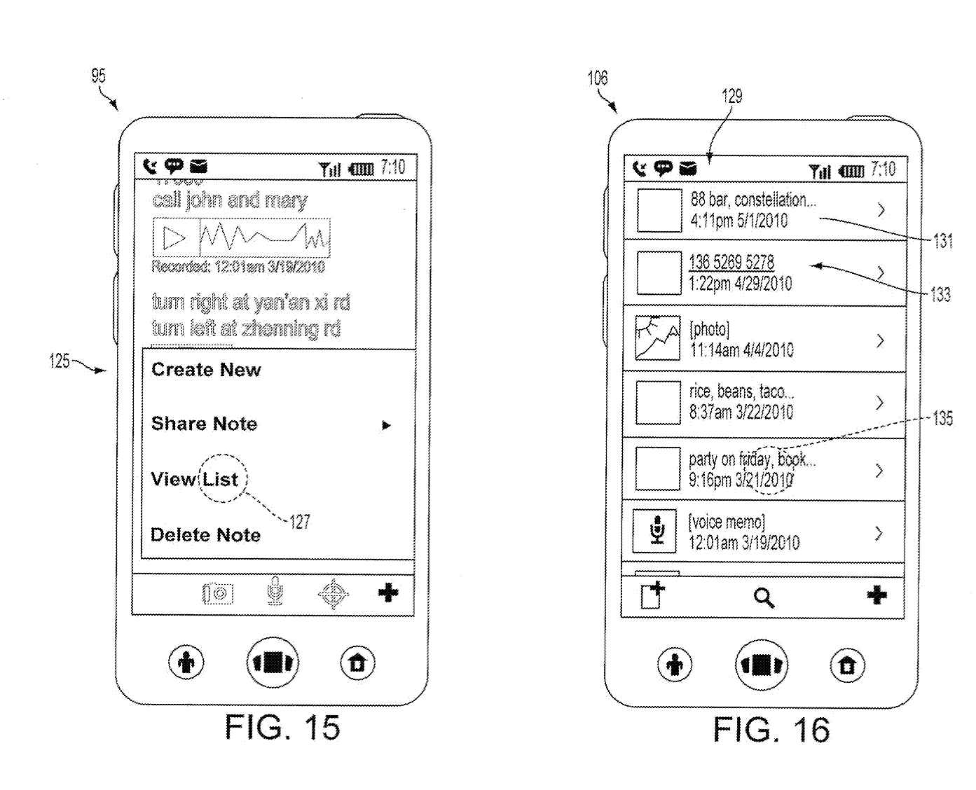

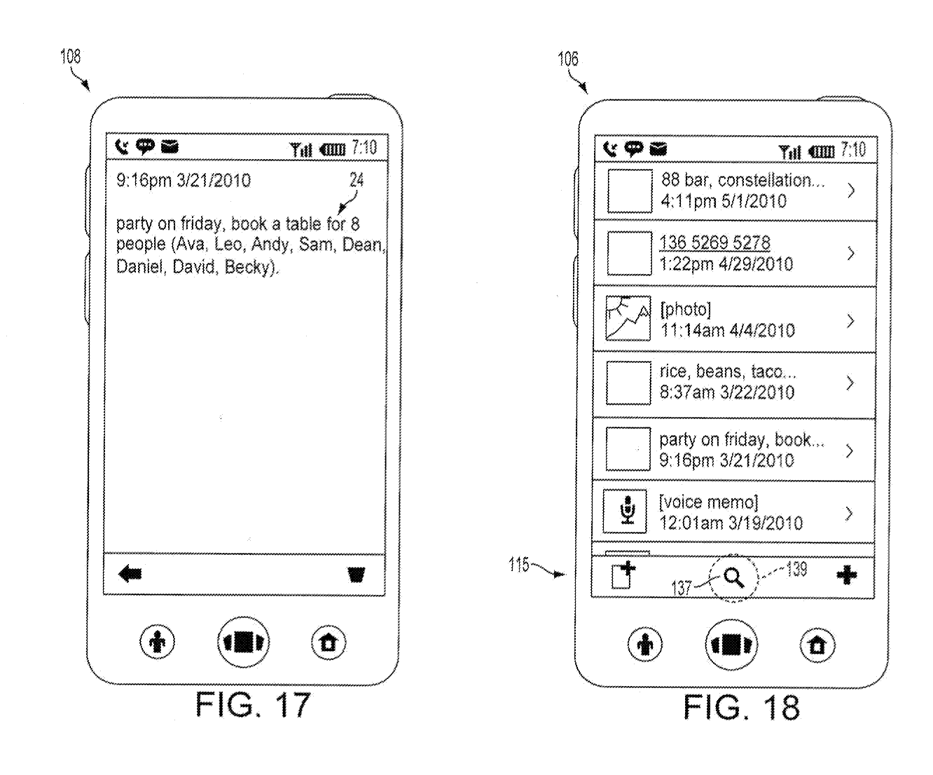

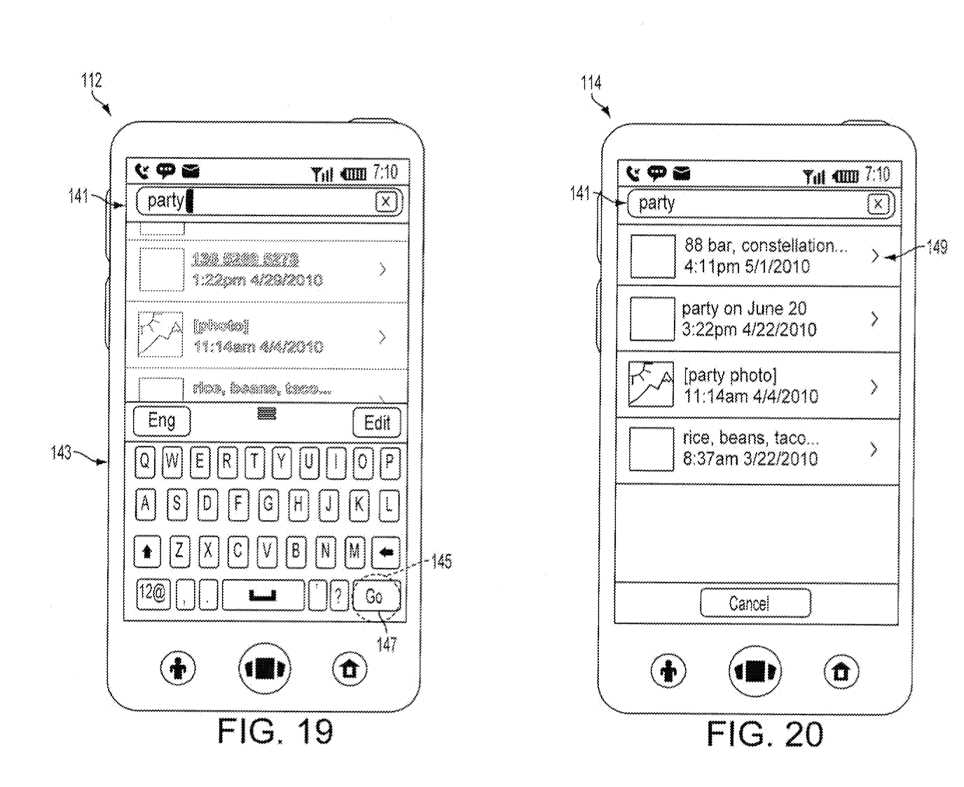

Referring to FIGS. 13-20, in an aspect, an example of a series of user interfaces associated with operation of note-taking application 12 on computer device 10 for searching for and viewing a list of notes includes, referring to FIG. 13, receiving an application-invoking input 101 while computer 10 is displaying a home user interface (also referred to as a “home screen”) 91. Application-invoking input 101 may be any input that launches note-taking application 12, such as but not limited to a gesture received on a touch-sensitive display, a key press, etc. Referring to FIG. 14, note-taking user interface 93, e.g. such as note-taking user interface 13 (FIG. 1) discussed previously, is displayed. In an aspect, note-taking user interface 93 may include one or more previously saved notes 103, which may include one or more information 24 (FIG. 1), and which may be represented in one or more different formats. For example, the formats may include text 105, an icon representing an audio file 107, a thumbnail of a photograph 109, or any other format or representation of information 24 (FIG. 1). Receiving a selection 111 of one of the items 113 in the menu 115 reveals available actions. For example, items 113 may include, but are not limited to, a camera action 117 for launching a camera application, an audio action 119 for launching an audio application, a location action 121 for launching a position-location application, and a “more actions” action 123 for generating another window of additional available actions. Referring to FIGS. 14 and 15, receiving selection 111 of the key corresponding to “more actions” 123 triggers generation of a new user interface 95 that lists various available actions 125, such as actions relating to the note-taking application 12 including but not limited to creating a new note, sharing a note, viewing a list of notes, and deleting a note. For example, referring to FIGS. 15 and 16, receiving a selection 127 of a “view list” action causes generation of a note list user interface 106 that includes a plurality of notes 129, which may be an ordered list. In one example, the plurality of notes 129 may be ordered chronologically based on a date and time 131 corresponding to each note. IN another aspect, if a matching pattern (as discussed above) is identified in one of the notes 129, then the identified pattern 133 may be highlighted or surfaced as an actionable link. Additionally, as mentioned previously, each of notes 129 may include one or more types of information 24 (FIG. 1) represented in one or more manners. Referring to FIGS. 16 and 17, receiving a selection 135 of one of the notes 129 causes generation of a note user interface 108 that displays information 24 corresponding to the respective note, which may be editable. Referring to FIG. 18, in another aspect of a note list user interface 106, menu 115 may include a search menu item 137. Referring to FIGS. 18 and 19, upon receiving a selection 139 of the search menu item 137, a query user interface 112 is generated, which can receive a user input query 141, such as via a virtual keypad 143. Referring to FIGS. 19 and 20, upon receiving a selection 145 of a search command (also referred to as “Go”) 147, a search results user interface 114 is generated, which includes any stored notes 149 having information that matches query 141.

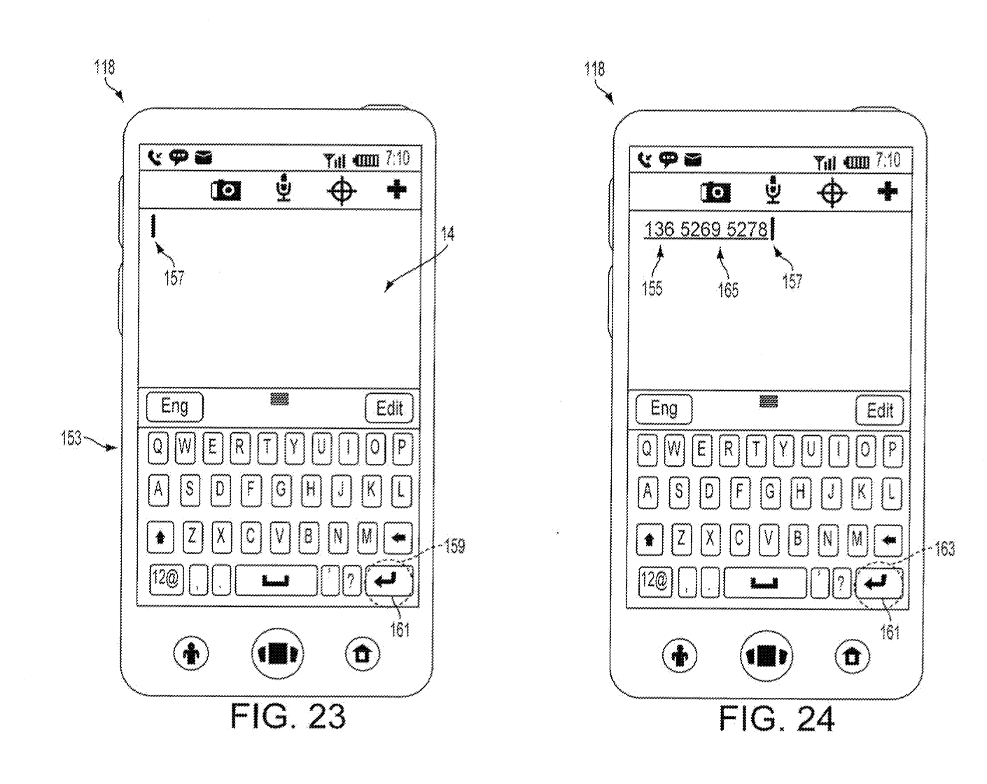

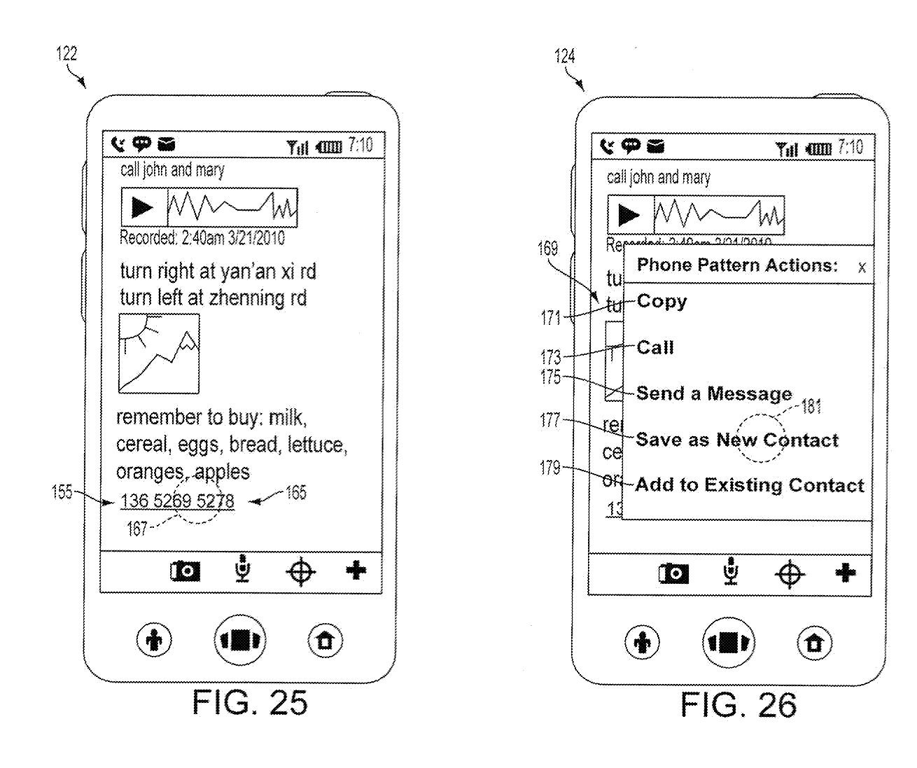

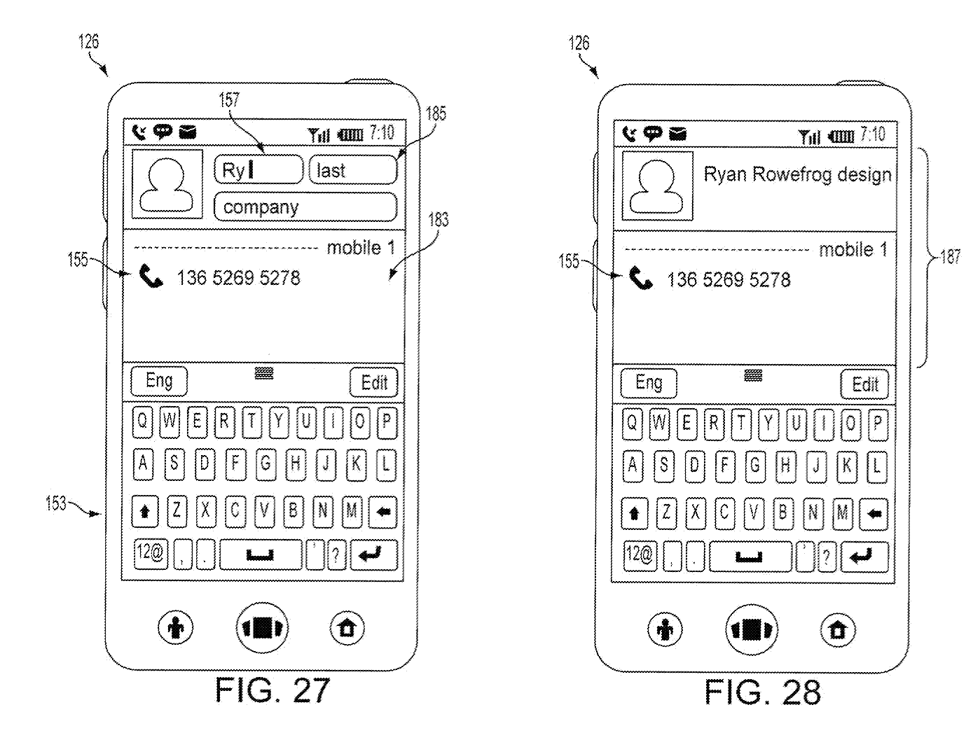

Referring to FIGS. 21-28, in an aspect, an example of a series of user interfaces associated with operation of note-taking application 12 on computer device 10 for capturing and saving a phone number includes, referring to FIGS. 21 and 22, receiving application-invoking input 101 while computer 10 is displaying home user interface (also referred to as a “home screen”) 91, and receiving a note-invoking input 151 while note-taking user interface 93 is displayed. Referring to FIGS. 23 and 24, a note-taking user interface 118 is generated, which includes note-display area 14, as well as a virtual keypad 153 including keys for typing in a phone number 155 into note-display area 14. In an aspect, for example, a cursor 157 may be activated in note-display area 14 based on receiving an input 159, such as a user selecting a return key 161. Further, referring to FIGS. 24 and 25, phone number 155 may be saved in an updated note-taking user interface 122 by selecting a “save” input 163, such as return key 161. In an aspect, for example, if phone number 155 comprises an identified pattern 42 (FIG. 1), then phone number 155 may include an indicator 165, such as underlining, highlighting, coloring, etc., to identify phone number 155 as being associated with one or more actions 76 or action identifiers/keys 79 (FIG. 4). Accordingly, referring to FIGS. 25 and 26, phone number 155 with indicator 165 may be referred to as an “action link,” since receiving a selection 167 of phone number 155 with indicator 165 causes generation of a phone pattern action user interface 124, which includes one or more actions 169, e.g. actions 76 (FIG. 4), associated with the detected phone pattern. For instance, in this example, actions 169 include but are not limited to a Copy action 171, a Call action 173, a Send a Message action 175, a Save as New Contact action 177, and an Add to Existing Contact action 179. Referring to FIGS. 26-28, in an example of one aspect, upon receiving a selection 181 of Save as New Contact action 177, a user contact record user interface 126 is generated with phone number 155 already populated in a phone number field 183. Additionally, referring to FIGS. 27 and 28, contact record user interface 126 may include virtual keypad 153 having keys to control positioning of cursor 157 in additional contact fields 185, such as a first name field, a last name field, a company name field, etc., in order to complete and save the contact record 187.

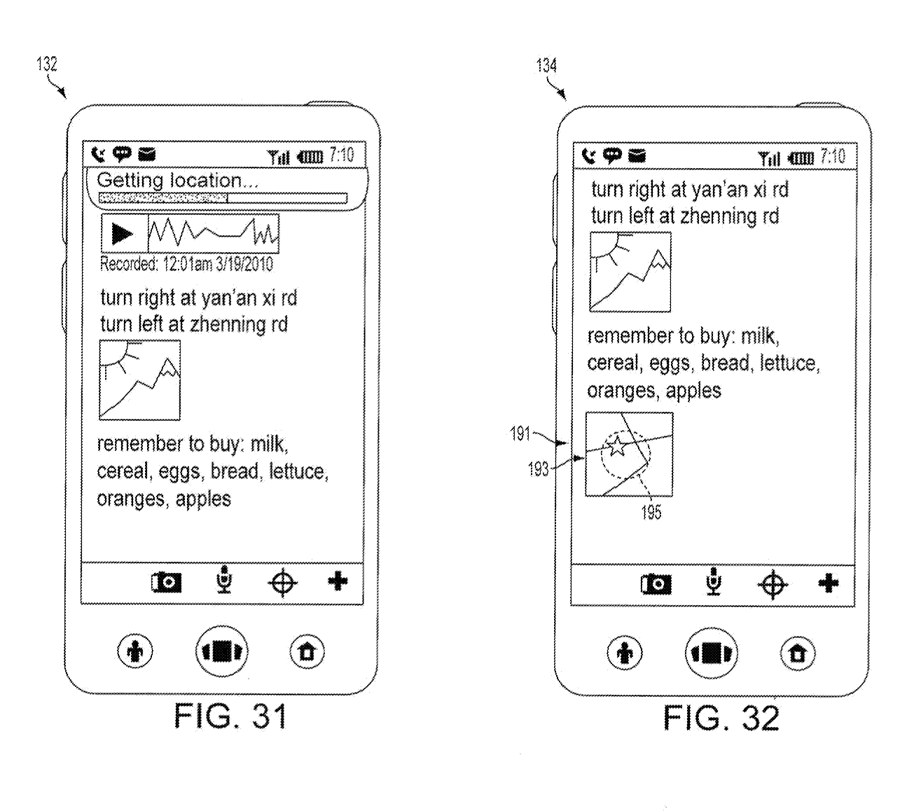

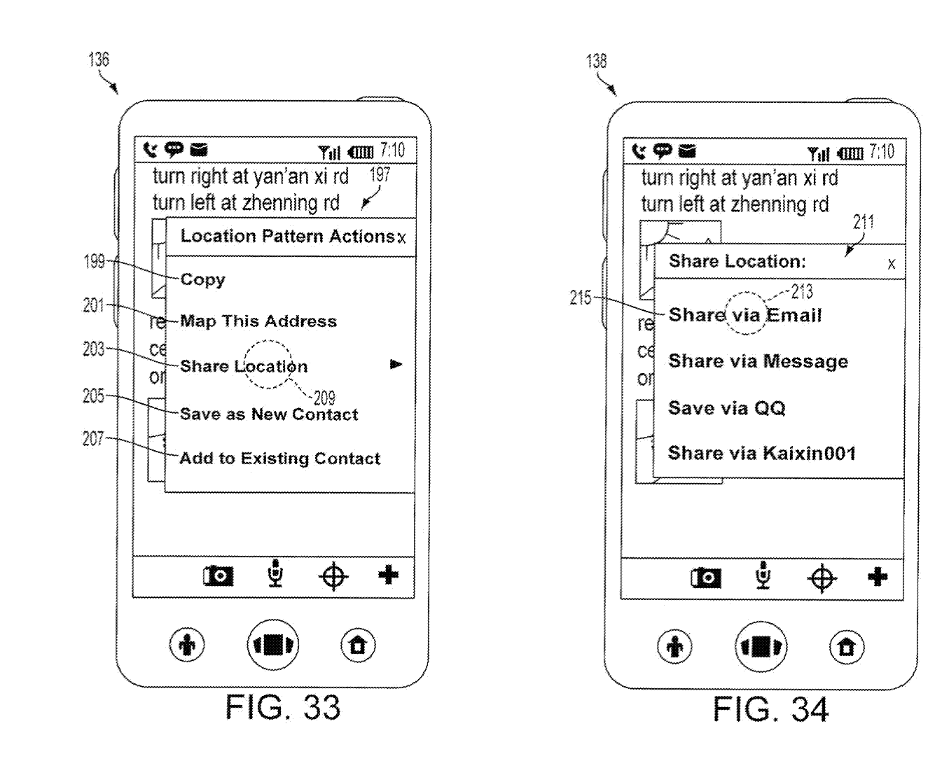

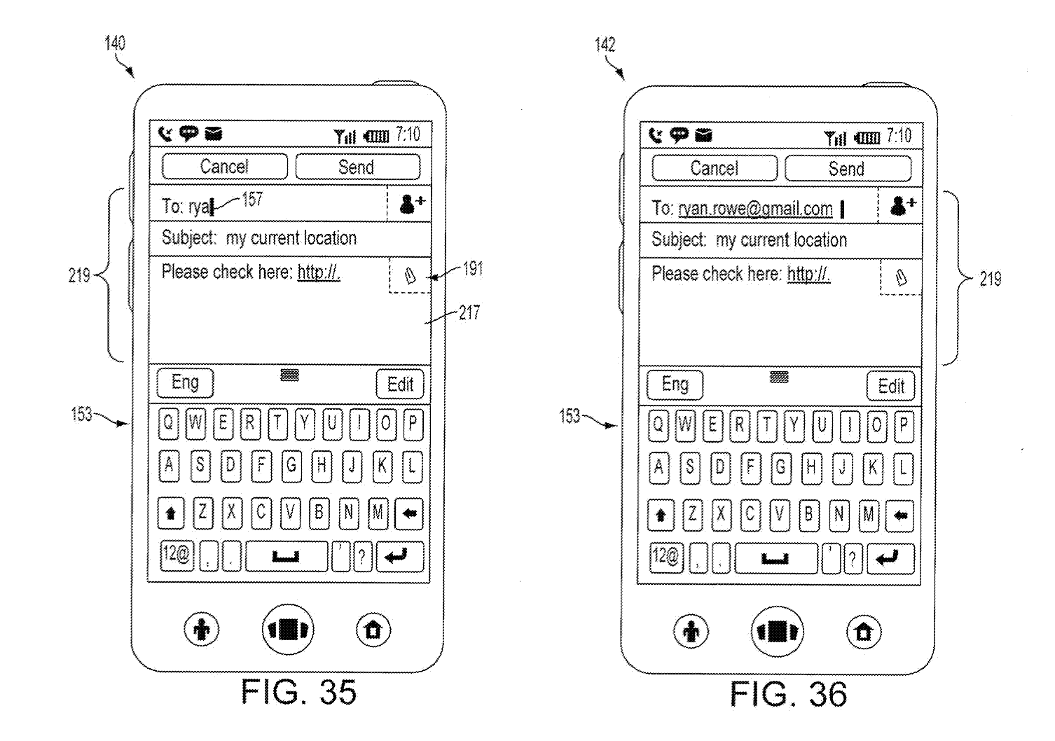

Referring to FIGS. 29-36, in an aspect, an example of a series of user interfaces associated with operation of note-taking application 12 on computer device 10 for capturing and saving a geographic location, also referred to as a geo-tag, includes, referring to FIGS. 29-30, receiving application-invoking input 101 while computer 10 is displaying home user interface (also referred to as a “home screen”) 91, and receiving a location capture input 189 while note-taking user interface 93 is displayed. For example, location capture input 189 selects location action 121. In one optional aspect, referring to FIG. 31, while waiting for a determination of a current geographic location of computer device 10, a location capture status user interface 132 may be displayed that provides a user with feedback as to how the acquisition of the current geographic position is proceeding. Referring to FIG. 32, when a current location is determined, a location representation 191 is appended to the end of the initial note-taking user interface 122 (FIG. 30), thereby creating an updated note-taking user interface 134. In an aspect, updated note-taking user interface automatically scrolls to allow the latest information 24 (FIG. 1), e.g. location representation 191, to be viewable. In an aspect, location representation 191 may included a pattern matched indication 193 that identifies that the current location matches a stored pattern. Referring to FIG. 33, in this example, upon receiving a selection 195 of location representation 191 including pattern matched indication 193, such as but not limited to an icon or a highlight, a location pattern actions user interface 136 is generated, including one or more actions 197 associated with the identified location pattern. For example, the one or more actions 197 may include, but are not limited to, a Copy action 199, a Map This Address action 201, a Share Location action 203, a Save As New Contact action 205, and an Add To Existing Contact action 207. Referring to FIG. 34, in one aspect, if a selection 209 is received for Share Location action 203, then a share location user interface 138 is generated that includes a sub-menu of actions 211. For example, actions 211 may include one or more action identifiers associated with communications-type applications that can be used to share the current geographic location or location representation 191 (FIG. 32). Referring to FIGS. 34 and 35, if a selection 213 is received for one of actions 211, such as a Share via Email action 215, then a compose email user interface 140 may be generated including current location or location representation 191 already populated in a field, such as in a body portion 217 of a message 219. In an aspect, since current location or location representation 191 included indicator 193 identifying an identified pattern 42 (FIG. 1), then indicator 193 may be included in body portion 217 of message 219 to indicate that location representation 191 including indicator 193 is an actionable item. Referring to FIGS. 35 and 36, compose email user interface 140 may include virtual keypad 153 including keys for positioning cursor within email fields 219, such as a To field, a Subject field, and body portion 217, and for initiating transmission, e.g. “sending,” a completed message.

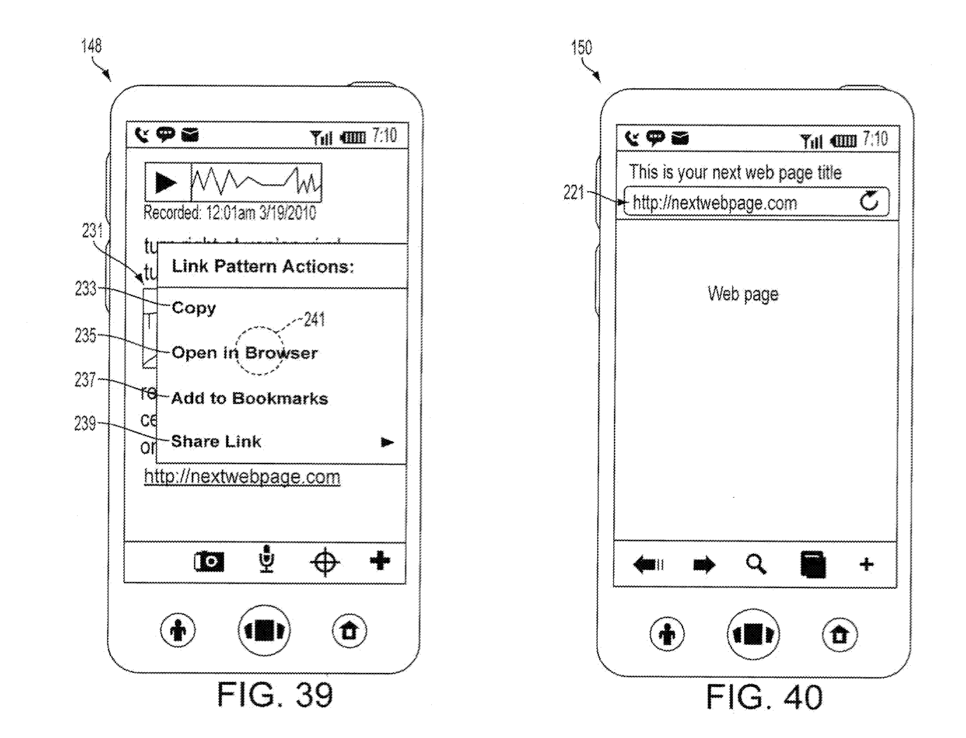

Referring to FIGS. 37-40, in an aspect, an example of a series of user interfaces associated with operation of note-taking application 12 on computer device 10 for capturing and saving a universal resource locator (URL) link includes, referring to FIGS. 37 and 38, typing a URL 221 into a note-taking user interface 144, receiving an input 223 to save the URL 221 in the note 225, and receiving a selection 227 of URL 221 in note-taking user interface 146. In an aspect, URL 221 may include a pattern-matched indicator 229, such as but not limited to highlighting and/or underlining, to identify to a user that URL 221 matches a pattern 78 (FIG. 4) in an action registry 72 (FIG. 4), and thus is an actionable item. Referring to FIG. 39, selection 227 (FIG. 38) causes generation of a link pattern actions user interface 148, which includes one or more action identifiers or actions 231 that may be taken based on URL 221 matching a registered pattern. For example, one or more action identifiers or actions 231 may include, but are not limited to, actions such as Copy 233, Open In Browser 235, Add to Bookmarks 237 and Share Link 239. Further, for example, in an aspect, upon receiving a selection 241 of Open In Browser 235, a web browser application on the computer device is automatically launched and the web page corresponding to URL 221 is automatically retrieved, resulting in web page user interface 150 (FIG. 40).

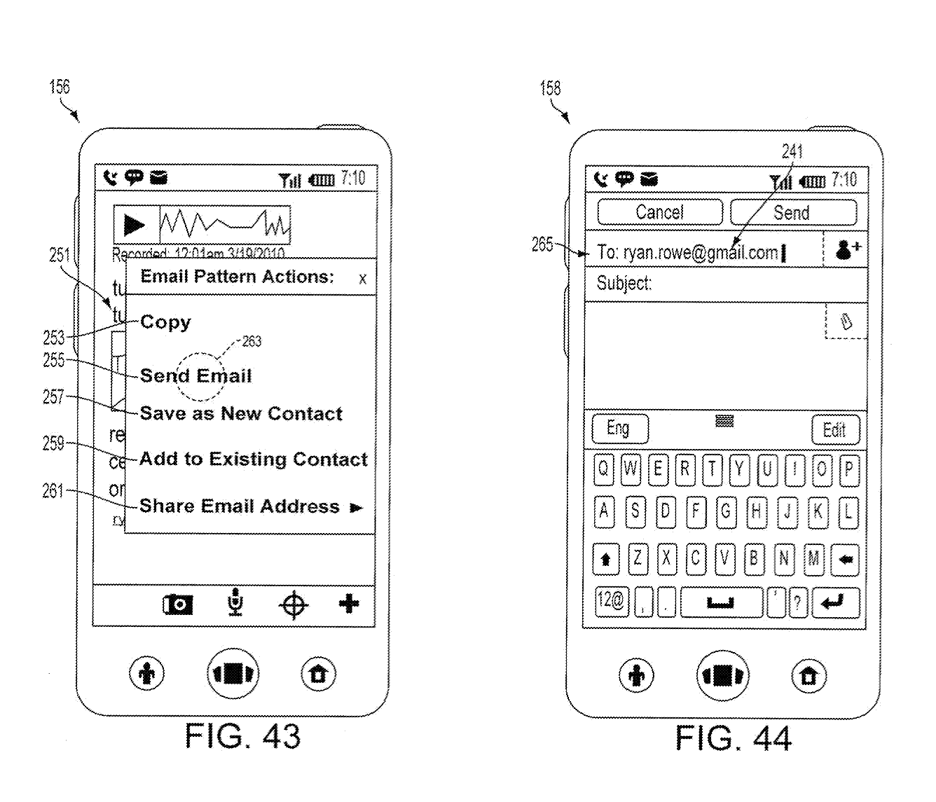

Referring to FIGS. 41-44, in an aspect, an example of a series of user interfaces associated with operation of note-taking application 12 on computer device 10 for capturing and saving an email address includes, referring to FIGS. 41 and 42, typing an email address 241 into a note-taking user interface 152, receiving an input 243 to save email address 241 in the note 245, and receiving a selection 247 of email address 241 in note-taking user interface 154. In an aspect, email address 241 may include a pattern-matched indicator 249, such as but not limited to highlighting and/or underlining, to identify to a user that email address 241 matches a pattern 78 (FIG. 4) in an action registry 72 (FIG. 4), and thus is an actionable item. Referring to FIG. 43, selection 247 (FIG. 42) causes generation of an email pattern actions user interface 156, which includes one or more action identifiers or actions 251 that may be taken based on email address 241 matching a registered pattern. For example, one or more action identifiers or actions 251 may include, but are not limited to, actions such as Copy 253, Send Email 255, Save As New Contact 257, Add To Existing Contact 259, and Share Email Address 261. Further, for example, in an aspect, upon receiving a selection 263 of Send Email 255, an email application on the computer device is automatically launched and email address 241 is automatically populated in a “To” field 265 of a compose email user interface 158 (FIG. 44), thereby enabling efficient composition of an email to email address 241.

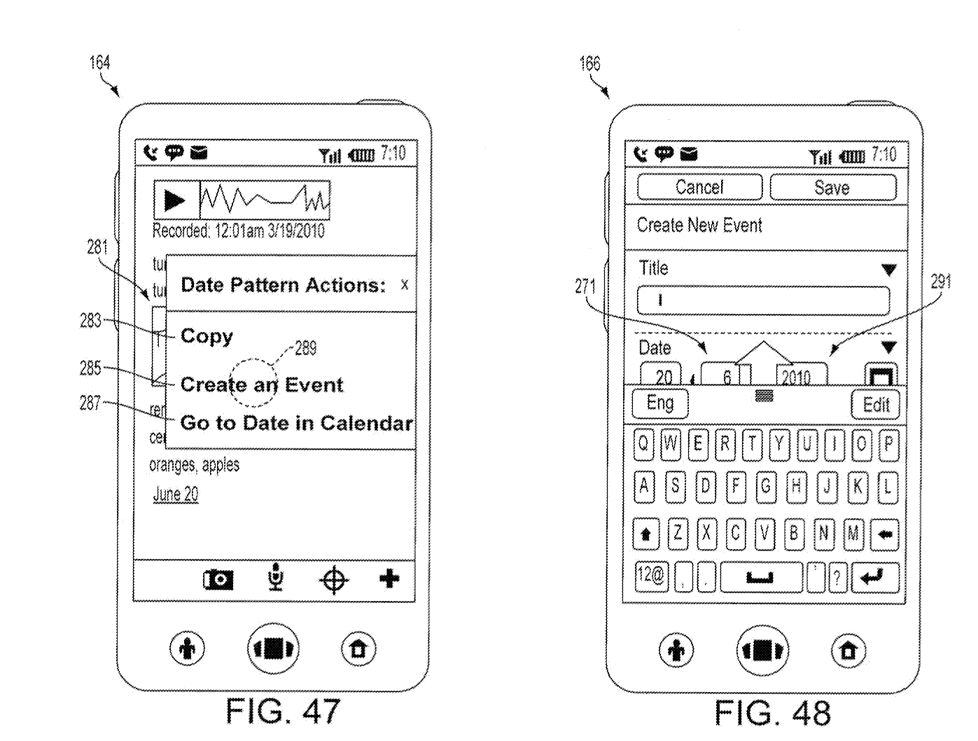

Referring to FIGS. 45-48, in an aspect, an example of a series of user interfaces associated with operation of note-taking application 12 on computer device 10 for capturing and saving a date includes, referring to FIGS. 45 and 46, typing all or a portion of a date 271 into a note-taking user interface 160, receiving an input 273 to save date 271 in the note 275, and receiving a selection 277 of date 271 in note-taking user interface 162. In an aspect, date 271 may include a pattern-matched indicator 279, such as but not limited to highlighting and/or underlining, to identify to a user that date 271 matches a pattern 78 (FIG. 4) in an action registry 72 (FIG. 4), and thus is an actionable item. Referring to FIG. 47, selection 277 (FIG. 46) causes generation of a date pattern actions user interface 164, which includes one or more action identifiers or actions 281 that may be taken based on date 271 matching a registered pattern. For example, one or more action identifiers or actions 281 may include, but are not limited to, actions such as Copy 283, Create An Event 285, and Go To Date In Calendar 287. Further, for example, in an aspect, upon receiving a selection 289 of Create An Event 285, a calendar application on the computer device is automatically launched and date 271 is automatically populated in a “Date” field 291 of a create calendar event user interface 166 (FIG. 48), thereby enabling efficient composition of a calendar event associated with date 271.

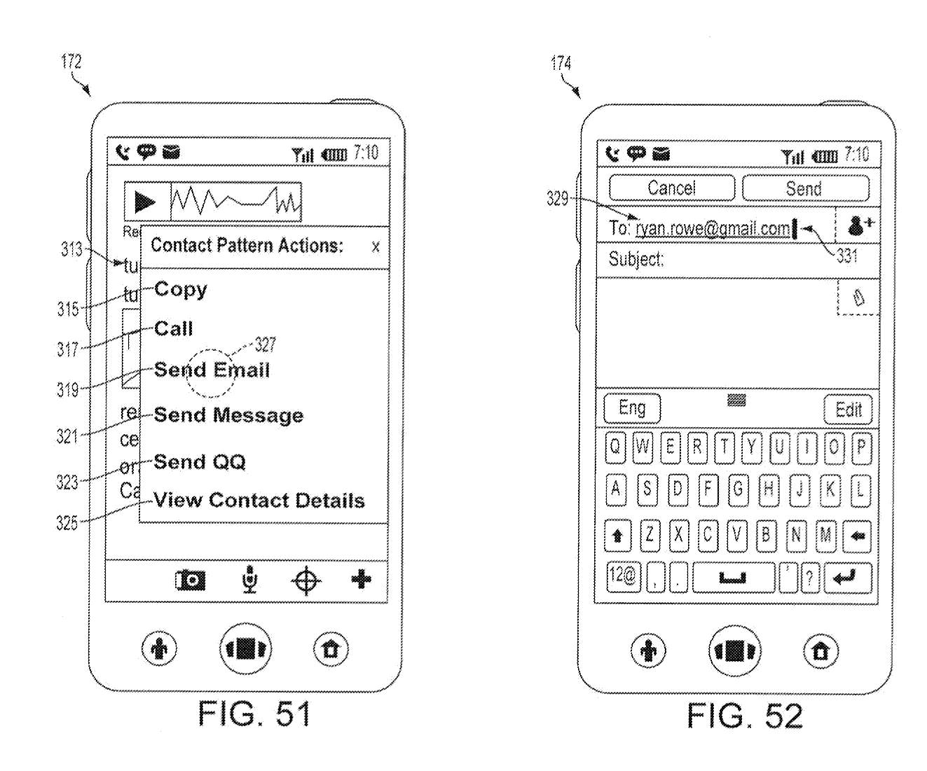

Referring to FIGS. 49-52, in an aspect, an example of a series of user interfaces associated with operation of note-taking application 12 on computer device 10 for capturing and saving a contact name includes, referring to FIGS. 49 and 50, typing all or a portion of a name 301 into a note-taking user interface 168, receiving an input 303 to save name 301 in the note 305, and receiving a selection 307 of name 301 in note-taking user interface 170. In an aspect, name 301 may include a pattern-matched indicator 309, such as but not limited to highlighting and/or underlining, to identify to a user that name 301 matches a pattern 78 (FIG. 4) in an action registry 72 (FIG. 4), and thus is an actionable item. Referring to FIG. 51, selection 311 (FIG. 50) causes generation of a contact pattern actions user interface 172, which includes one or more action identifiers or actions 313 that may be taken based on name 301 matching a registered pattern. For example, one or more action identifiers or actions 313 may include, but are not limited to, actions such as Copy 315, Call 317, Send Email 319, Send Message 321, Send QQ (e.g., a proprietary type of message) 323, and View Contact Details 325. Further, for example, in an aspect, upon receiving a selection 327 of Send Email 319, an email application on the computer device is automatically launched and an email address 329, stored in a contacts or personal information manager database, corresponding to name 301 is automatically populated in a “To” field 331 of a compose email user interface 174 (FIG. 52), thereby enabling efficient composition of a new email message to a stored contact matching with name 301.

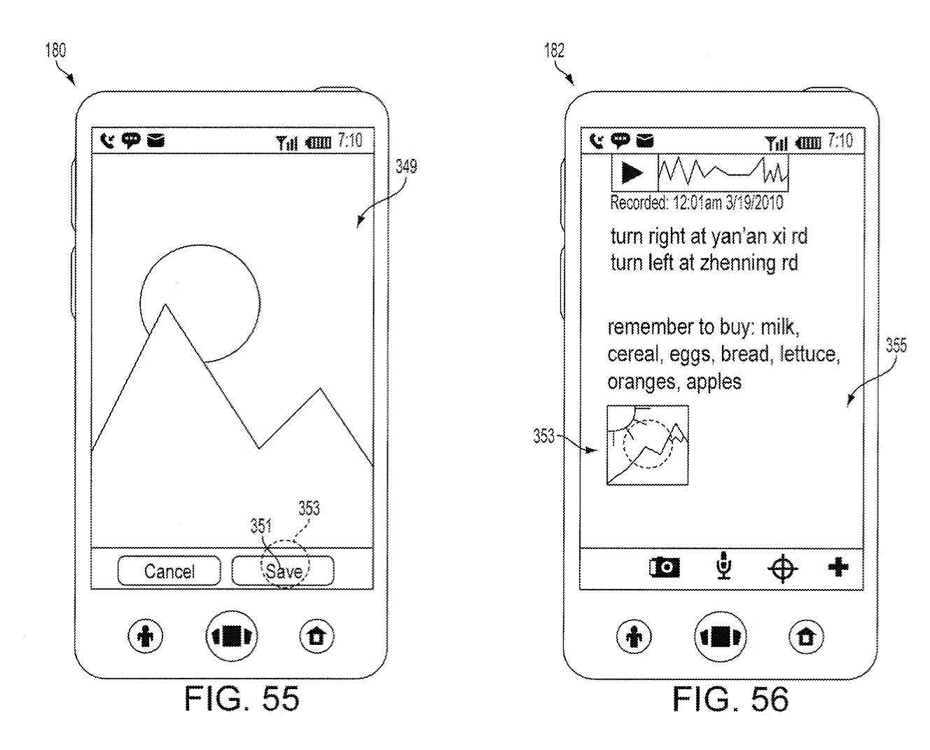

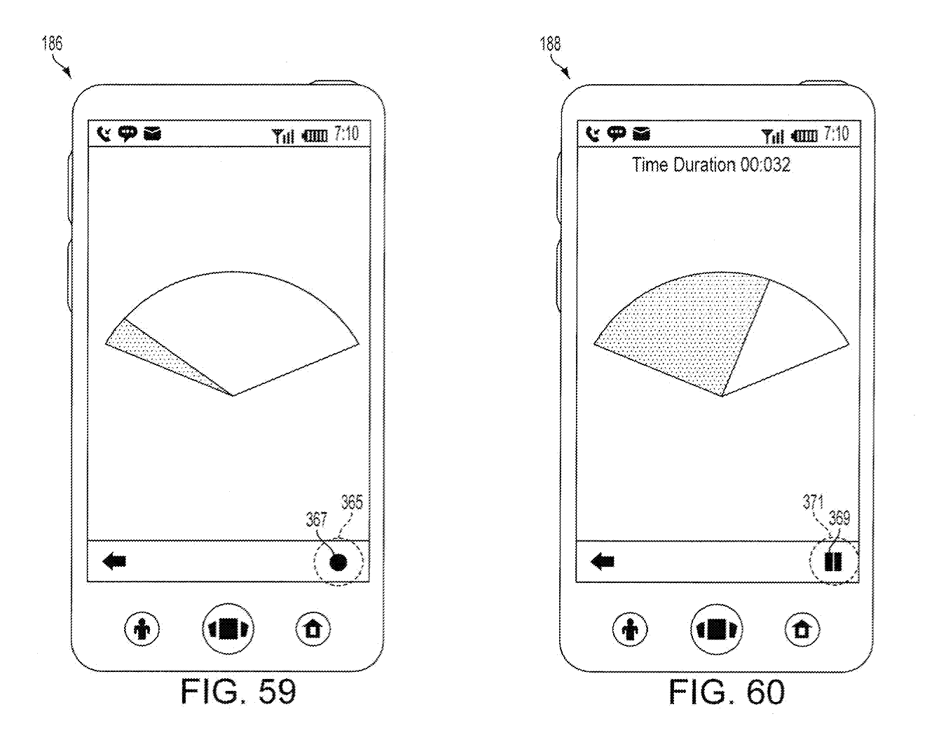

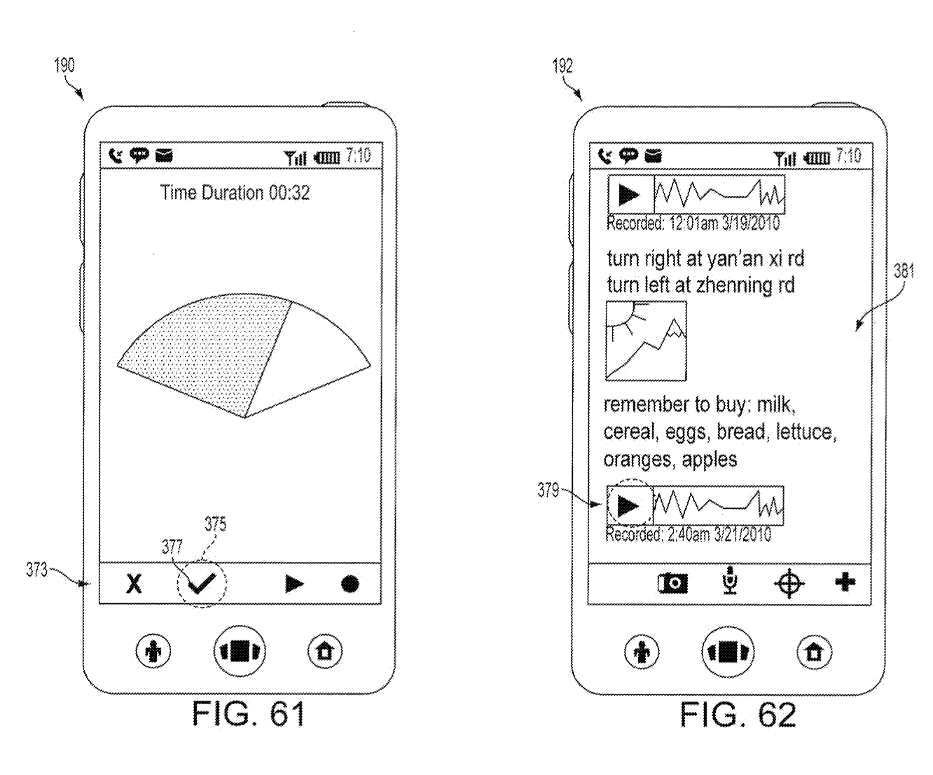

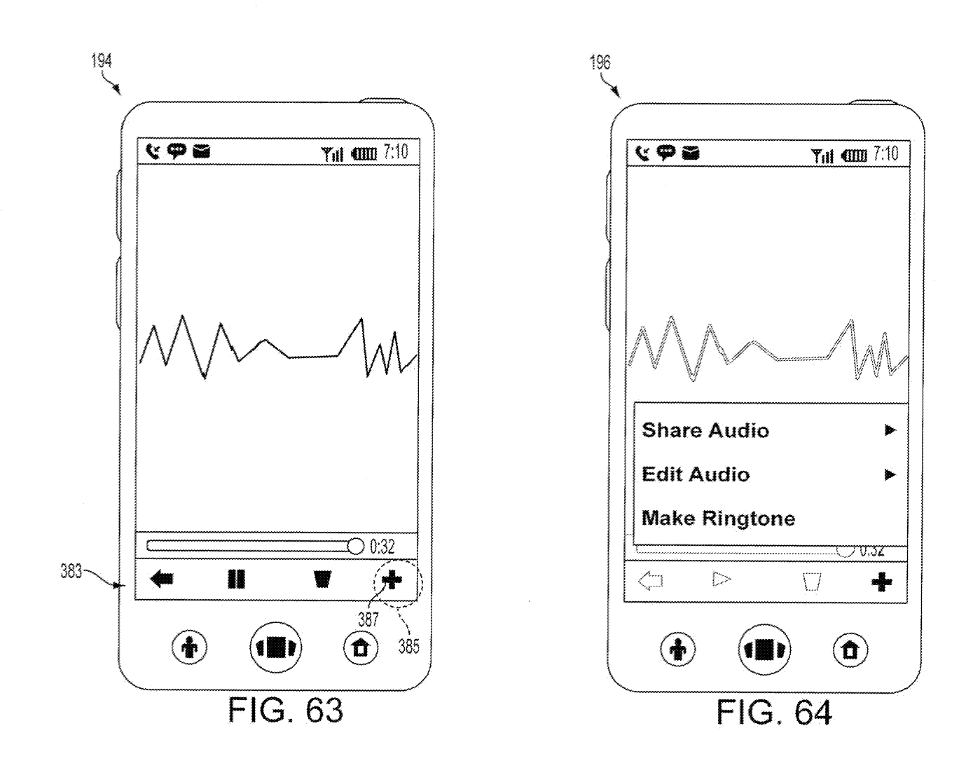

Referring to FIGS. 53-56, in an aspect, an example of a series of user interfaces associated with operation of note-taking application 12 on computer device 10 for capturing and saving a photograph includes, referring to FIGS. 53 and 54, receiving a selection 341 of a launch camera application action or action identifier 343 on a note-taking user interface 176, thereby automatically launching a camera application on computer device and generating a camera application user interface 178. Upon receiving a selection 345 of a take a picture action or action identifier 347, a capture photo user interface 180 (FIG. 55) is generated, and an image 349 can be captured upon receiving a selection 351 of a save action or action identifier 353. Alternatively, selection of a Cancel action or action identifier may return the user to an active camera mode. Further, in an aspect, selection 351 of Save 353 may cause image 349 to be saved in a photo album associated with camera application or computer device, and also may cause a thumbnail version 354 of image 349 to be saved in note 355, referring to note-taking user interface 182 (FIG. 56). In an aspect, upon selecting thumbnail version 353, computer device 10 may automatically launch a full image view service, such as may be associated with the photo album, to generate a full screen view of image 349. Referring to FIGS. 57-64, in an aspect, an example of a series of user interfaces associated with operation of note-taking application 12 on computer device 10 for capturing and saving an audio file 10 includes, referring to FIGS. 57 and 58, automatically launching note-taking application 12 and note-taking user interface 93 in response to receiving a predetermined input 361 on a home user interface 91. Upon receiving a selection 363 of audio action or audio action identifier 119, an audio recorder application on computer device 10 is automatically launched, causing generation of a record audio user interface 186 (FIG. 59). Upon receiving a selection 365 of a record action or action identifier 367, an audio recording user interface 188 (FIG. 60) represents the audio being recorded, which proceeds until a pause or stop action or action identifier 369 is selected 371. In an aspect, after recording audio, a continuing audio recording user interface 190 (FIG. 61) is generated, including one or more actions or action identifiers 373. The one or more actions or action identifiers 373 may include, but are not limited to, actions such as a Record action to continue recording, a Play action to play the captured recording, a Save action to save the recording, or a Cancel action to delete the recording. For example, in an aspect, upon receiving a selection 375 of a Save action 377 (FIG. 61), an updated note-taking user interface 192 (FIG. 62) is generated and includes a thumbnail representation 379 of the recording in the note 381. In an aspect, receiving a selection 383 of thumbnail representation 379 of recording automatically launches an audio player application on computer device 10, including an audio player user interface 194 (FIG. 63) and one or more actions or action identifiers 383 corresponding to an audio file. For example, the one or more actions or action identifiers 383 may include, but are not limited to, actions or action identifiers such as Rewind, Pause, Stop, and a More Actions. In an aspect, upon receiving a selection 385 of a More Actions identifier 387, computer device 10 may automatically launch an audio action user interface 196 (FIG. 64) including additional actions 389, such as but not limited to Share Audio 391, Edit Audio 393 and Make Ringtone 395, thereby enabling efficient input of the recorded audio to one or more other applications resident on computer device 10.

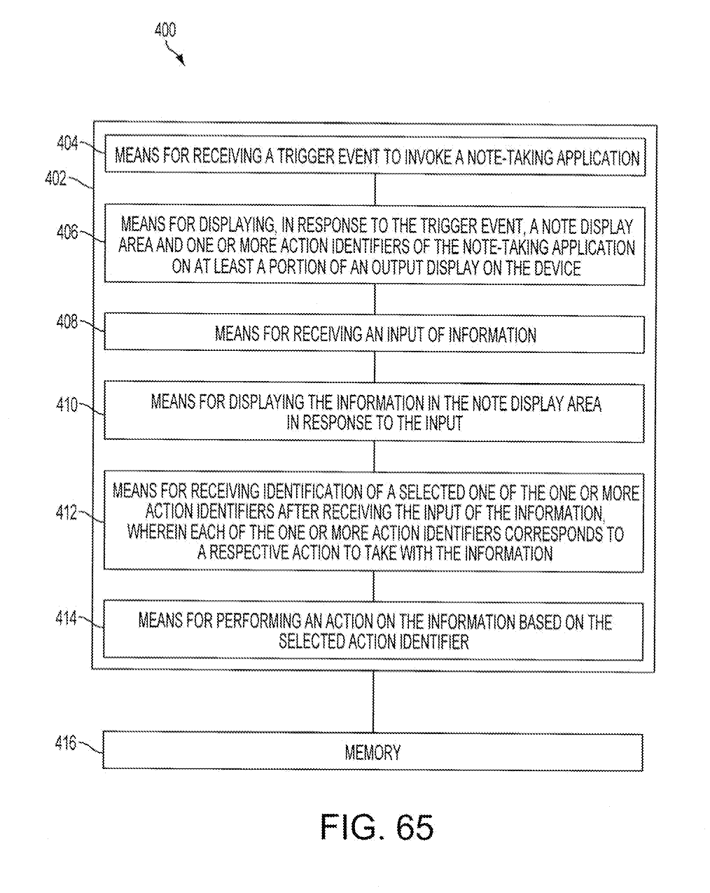

Referring to FIG. 65, based on the foregoing descriptions, an apparatus 400 for capturing user-entered information may reside at least partially within a computer device, including but not limited to a mobile device, such as a cellular telephone, or a wireless device in a wireless communications network. For example, apparatus 400 may include, or be a portion of, computer device 11 of FIG. 1. It is to be appreciated that apparatus 400 is represented as including functional blocks, which can be functional blocks that represent functions implemented by a processor, software, or combination thereof (e.g., firmware). Apparatus 400 includes a logical grouping 402 of electrical components that can act in conjunction. For instance, logical grouping 402 can include means for receiving a trigger event to invoke a note-taking application (Block 404). For example, referring to FIG. 1, means for means for receiving a trigger event 404 may include input mechanism 28 of computer device 10. Further, logical grouping 402 can include means for displaying, in response to the trigger event, a note display area and one or more action identifiers of the note-taking application on at least a portion of an output display on the device (Block 406). For example, referring to FIG. 1, means for means for displaying a note display area 406 may include display 20. Additionally, logical grouping 402 can include means for receiving an input of information (Block 408). For example, referring to FIG. 1, means for receiving an input of information 408 may include input mechanism 28. Further, logical grouping 402 can include means for displaying the information in the note display area in response to the input (Block 410). For example, referring to FIG. 1, means for displaying the information 410 may include display 20. Also, logical grouping 402 can include means for receiving identification of a selected one of the one or more action identifiers after receiving the input of the information, wherein each of the one or more action identifiers corresponds to a respective action to take with the information (Block 412). For example, referring to FIG. 1, means for receiving identification of a selected one of the one or more action identifiers 412 may include input mechanism 28. Moreover, logical grouping 402 can include means for performing an action on the information based on the selected action identifier (Block 414). For example, referring to FIG. 1, means for performing the action 414 may include one or more applications 32.

Alternatively, or in addition, in an aspect, apparatus 400 may include at least one processor or one or more modules of a processor operable to perform the means described above. For example, referring to FIG. 2, the at least one processor and/or processor modules may include processor 60.

Additionally, apparatus 400 may include a memory 416 that retains instructions for executing functions associated with electrical components 404, 406, 408, 410, 412, and 414. While shown as being external to memory 416, it is to be understood that one or more of electrical components 404, 406, 408, 410, 412, and 414 may exist within memory 416. For example, in an aspect, memory 416 may include memory 62 and/or data store 66 of FIG. 2.

In summary, for example, in an aspect that should not be construed as limiting, the note-taking application is designed to accept text entry after a simple invoking input, such as a gesture on a touch-sensitive display, which launches the note-taking application from anywhere in the user interface. Once activated, the note-taking application obtains information, and may be initially populated with a default set of actions to take with respect to the information. Optionally, the note-taking application may include a pattern detection component that monitors the information as it is received, identifies any patterns in the information, and initiates a change to the default set of actions based on an identified pattern. For example, if a user types in a phone number, then an action option such as “save to phone book” and/or “call number” may dynamically appear in a revised set of actions. Thus, the note-taking application allows a user to capture information, and then decide how to act on the information.

As used in this application, the terms “application,” “component,” “module,” “system” and the like are intended to include a computer-related entity, such as but not limited to hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Furthermore, various aspects are described herein in connection with a computer device, which can be a wired terminal or a wireless terminal. A terminal can also be called a system, device, subscriber unit, subscriber station, mobile station, mobile, mobile device, remote station, remote terminal, access terminal, user terminal, terminal, communication device, user agent, user device, or user equipment (UE). A wireless terminal may be a cellular telephone, a satellite phone, a cordless telephone, a Session Initiation Protocol (SIP) phone, a wireless local loop (WLL) station, a personal digital assistant (PDA), a handheld device having wireless connection capability, a computing device, or other processing devices connected to a wireless modem.

Moreover, any use of the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

The techniques described herein may be used for computer devices operable in various wireless communication systems such as CDMA, TDMA, FDMA, OFDMA, SC-FDMA and other systems. The terms “system” and “network” are often used interchangeably. A CDMA system may implement a radio technology such as Universal Terrestrial Radio Access (UTRA), cdma2000, etc. UTRA includes Wideband-CDMA (W-CDMA) and other variants of CDMA. Further, cdma2000 covers IS-2000, IS-95 and IS-856 standards. A TDMA system may implement a radio technology such as Global System for Mobile Communications (GSM). An OFDMA system may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDM, etc. UTRA and E-UTRA are part of Universal Mobile Telecommunication System (UMTS). 3GPP Long Term Evolution (LTE) is a release of UMTS that uses E-UTRA, which employs OFDMA on the downlink and SC-FDMA on the uplink. UTRA, E-UTRA, UMTS, LTE and GSM are described in documents from an organization named “3rd Generation Partnership Project” (3GPP). Additionally, cdma2000 and UMB are described in documents from an organization named “3rd Generation Partnership Project 2” (3GPP2). Further, such wireless communication systems may additionally include peer-to-peer (e.g., mobile-to-mobile) ad hoc network systems often using unpaired unlicensed spectrums, 802.xx wireless LAN, BLUETOOTH and any other short- or long-range, wireless communication techniques.

Various aspects or features presented herein may comprise systems that may include a number of devices, components, modules, and the like. It is to be understood and appreciated that the various systems may include additional devices, components, modules, etc. and/or may not include all of the devices, components, modules etc. discussed in connection with the figures. A combination of these approaches may also be used.

The various illustrative applications, functions, logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Additionally, at least one processor may comprise one or more modules operable to perform one or more of the steps and/or actions described above.

Further, the steps and/or actions of a method or algorithm described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. Further, the storage medium may be non-transitory. An exemplary storage medium may be coupled to the processor, such that the processor can read information from, and write information to, the storage medium.

In the alternative, the storage medium may be integral to the processor. Further, in some aspects, the processor and the storage medium may reside in an ASIC. Additionally, the ASIC may reside in a user terminal. In the alternative, the processor and the storage medium may reside as discrete components in a user terminal. Additionally, in some aspects, the steps and/or actions of a method or algorithm may reside as one or any combination or set of codes and/or instructions on a non-transitory machine readable medium and/or computer readable medium, which may be incorporated into a computer program product.

In one or more aspects, the functions described may be implemented in hardware, software, firmware, or any combination thereof. If implemented in software, the functions may be stored or transmitted as one or more instructions or code on a computer-readable medium. Computer-readable media includes both computer storage media and communication media including any medium that facilitates transfer of a computer program from one place to another. A storage medium may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection may be termed a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs usually reproduce data optically with lasers. Combinations of the above should also be included within the scope of computer-readable media.

While the foregoing disclosure discusses illustrative aspects and/or embodiments, it should be noted that various changes and modifications could be made herein without departing from the scope of the described aspects and/or embodiments as defined by the appended claims. Furthermore, although elements of the described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise.

What is claimed is:

1. A method of capturing user-entered information on a device, comprising:
receiving a trigger event to invoke a note-taking application;
displaying, in response to the trigger event, a note display area and one or more action identifiers of the note-taking application on at least a portion of an output display on the device;
receiving an input of information;
displaying the information in the note display area in response to the input;
receiving identification of a selected one of the one or more action identifiers after receiving the input of the information, wherein each of the one or more action identifiers corresponds to a respective action to take with the information; and
performing an action on the information based on the selected action identifier.

2. The method of claim 1, wherein each of the one or more action identifiers corresponds to a respective function of one or more of a plurality of applications on the device, and wherein performing the action further comprises executing the one of the plurality of applications corresponding to the selected action identifier to perform the respective function.

3. The method of claim 1, further comprising:
displaying an initial window on the output display corresponding to execution of one of a plurality of applications on the device;
wherein the receiving of the trigger event occurs during the initial window and execution of the one of the plurality of applications; and
wherein the displaying of the note display area and the one or more action identifiers at least partially overlays the initial window based on the note display area having a higher user interface privilege than the initial window.

4. The method of claim 3, further comprising:
stopping the displaying of the note display area and the one or more action identifiers of the note-taking application in response to the performing of the action; and
returning to the displaying of the initial window after the stopping.

5. The method of claim 1, further comprising:
receiving a registration of an action corresponding to an identified pattern for an application on the device;
determining a pattern in at least a part of the information;
determining if the pattern matches the identified pattern corresponding to the registration; and
changing, based on determining the pattern matches the identified pattern, the displaying of the one or more action identifiers to include a pattern-matched action identifier different from the one or more action identifiers.

6. The method of claim 1, wherein the displaying, in response to the trigger event, further comprises displaying a virtual keypad and one or more virtual action keys defining the one or more action identifiers, and wherein receiving the input of the information further comprises receiving at the virtual keypad.

7. The method of claim 1, further comprising stopping the displaying of the note display area and the one or more action identifiers of the note-taking application in response to the performing of the action.

8. The method of claim 1, further comprising displaying a confirmation message in response to completing the performing of the action.

9. The method of claim 1, wherein receiving the trigger event comprises at least one of receiving a user-input at a key, or receiving the user-input at a microphone, or receiving the user-input at a touch-sensitive display, or receiving the user-input at a motion sensor.

10. The method of claim 1, wherein receiving the input of the information includes receiving at least one of text information, voice information, audio information, geographic position or movement information, video information, graphic information, or photograph information.

11. The method of claim 1, wherein the displaying of the information further comprises displaying a representation of two or more types of different information.

12. At least one processor for capturing user-entered information on a device, comprising:
a first module for receiving a trigger event to invoke a note-taking application;
a second hardware module for displaying, in response to the trigger event, a note display area and one or more action identifiers of the note-taking application on at least a portion of an output display on the device;
a third module for receiving an input of information;
wherein the second hardware module is further configured for displaying the information in the note display area in response to the input;
wherein the third module is further configured for receiving identification of a selected one of the one or more action identifiers after receiving the input of the information, wherein each of the one or more action identifiers corresponds to a respective action to take with the information; and
a fourth module for performing an action on the information based on the selected action identifier.

13. The at least one processor of claim 12, wherein each of the one or more action identifiers corresponds to a respective function of one or more of a plurality of applications on the device, and wherein the fourth module for performing the action is further configured for executing the one of the plurality of applications corresponding to the selected action identifier to perform the respective function.

14. The at least one processor of claim 12, further comprising:
wherein the second hardware module is further configured for displaying an initial window on the output display corresponding to execution of one of a plurality of applications on the device;
wherein the first module receives the trigger event during displaying of the initial window and execution of the one of the plurality of applications; and
wherein the second hardware module is further configured for displaying the note display area and the one or more action identifiers to at least partially overlay the initial window based on the note display area having a higher user interface privilege than the initial window.

15. The at least one processor of claim 14, further comprising:
a fifth module for stopping the displaying of the note display area and the one or more action identifiers of the note-taking application in response to the performing of the action; and
a sixth module for returning to the displaying of the initial window after the stopping.

16. The at least one processor of claim 12, further comprising:
a fifth module for receiving a registration of an action corresponding to an identified pattern for an application on the device;
a sixth module for determining a pattern in at least a part of the information;
a seventh module for determining if the pattern matches the identified pattern corresponding to the registration; and
an eighth module for changing, based on determining the pattern matches the identified pattern, the displaying of the one or more action identifiers to include a pattern-matched action identifier different from the one or more action identifiers.

17. The at least one processor of claim 12, wherein the second hardware module is further configured for displaying, in response to the trigger event, a virtual keypad and one or more virtual action keys defining the one or more action identifiers, and wherein the third module for receiving the input of the information is further configured for receiving at the virtual keypad.

18. The at least one processor of claim 12, further comprising a fifth module for stopping the displaying of the note display area and the one or more action identifiers of the note-taking application in response to the performing of the action.

19. The at least one processor of claim 12, further comprising a fifth module for displaying a confirmation message in response to completing the performing of the action.

20. The at least one processor of claim 12, wherein the trigger event further comprises a user-input at a key, or the user-input at a microphone, or the user-input at a touch-sensitive display, or the user-input at a motion sensor.

21. The at least one processor of claim 12, wherein the input of the information further comprises at least one of text information, voice information, audio information, geographic position or movement information, video information, graphic information, or photograph information.

22. The at least one processor of claim 12, wherein the second hardware module for displaying of the information is further configured for displaying a representation of two or more types of different information.

23. A computer program product for capturing user-entered information on a device, comprising:
a non-transitory computer-readable medium comprising:
at least one instruction executable by a computer for receiving a trigger event to invoke a note-taking application;
at least one instruction executable by the computer for displaying, in response to the trigger event, a note display area and one or more action identifiers of the note-taking application on at least a portion of an output display on the device;
at least one instruction executable by the computer for receiving an input of information;
at least one instruction executable by the computer for displaying the information in the note display area in response to the input;
at least one instruction executable by the computer for receiving identification of a selected one of the one or more action identifiers after receiving the input of the information, wherein each of the one or more action identifiers corresponds to a respective action to take with the information; and
at least one instruction executable by the computer for performing an action on the information based on the selected action identifier.

24. The computer program product of claim 23, wherein each of the one or more action identifiers corresponds to a respective function of one or more of a plurality of applications on the device, and wherein the at least one instruction for performing the action further comprises at least one instruction for executing the one of the plurality of applications corresponding to the selected action identifier to perform the respective function.

25. The computer program product of claim 23, further comprising:
at least one instruction for displaying an initial window on the output display corresponding to execution of one of a plurality of applications on the device;
wherein the trigger event occurs during the initial window and execution of the one of the plurality of applications; and
wherein the displaying of the note display area and the one or more action identifiers at least partially overlays the initial window based on the note display area having a higher user interface privilege than the initial window.

26. The computer program product of claim 25, further comprising:
at least one instruction for stopping the displaying of the note display area and the one or more action identifiers of the note-taking application in response to the performing of the action; and
at least one instruction for returning to the displaying of the initial window after the stopping.

27. The computer program product of claim 23, further comprising:
at least one instruction for receiving a registration of an action corresponding to an identified pattern for an application on the device;
at least one instruction for determining a pattern in at least a part of the information;
at least one instruction for determining if the pattern matches the identified pattern corresponding to the registration; and
at least one instruction for changing, based on determining the pattern matches the identified pattern, the displaying of the one or more action identifiers to include a pattern-matched action identifier different from the one or more action identifiers.

28. The computer program product of claim 23, wherein the at least one instruction for displaying, in response to the trigger event, further comprises at least one instruction for displaying a virtual keypad and one or more virtual action keys defining the one or more action identifiers, and wherein the at least one instruction for receiving the input of the information further comprises at least one instruction for receiving at the virtual keypad.

29. The computer program product of claim 23, further comprising at least one instruction for stopping the displaying of the note display area and the one or more action identifiers of the note-taking application in response to the performing of the action.

30. The computer program product of claim 23, further comprising at least one instruction for displaying a confirmation message in response to completing the performing of the action.

31. The computer program product of claim 23, wherein the trigger event comprises at least one of a user-input at a key, or the user-input at a microphone, or the user-input at a touch-sensitive display, or the user-input at a motion sensor.

32. The computer program product of claim 23, wherein the input of the information includes at least one of text information, voice information, audio information, geographic position or movement information, video information, graphic information, or photograph information.

33. The computer program product of claim 23, wherein the at least one instruction for displaying of the information further comprises at least one instruction for displaying a representation of two or more types of different information.

34. A device for capturing user-entered information, comprising:
means for receiving a trigger event to invoke a note-taking application;
means for displaying, in response to the trigger event, a note display area and one or more action identifiers of the note-taking application on at least a portion of an output display on the device;
means for receiving an input of information;
means for displaying the information in the note display area in response to the input;
means for receiving identification of a selected one of the one or more action identifiers after receiving the input of the information, wherein each of the one or more action identifiers corresponds to a respective action to take with the information; and
means for performing an action on the information based on the selected action identifier.

35. The device of claim 34, wherein each of the one or more action identifiers corresponds to a respective function of one or more of a plurality of applications on the device, and wherein the means for performing the action further comprises means for executing the one of the plurality of applications corresponding to the selected action identifier to perform the respective function.

36. The device of claim 34, further comprising:
means for displaying an initial window on the output display corresponding to execution of one of a plurality of applications on the device;
wherein the receiving of the trigger event occurs during the initial window and execution of the one of the plurality of applications; and
wherein the means for displaying displays the note display area and the one or more action identifiers to at least partially overlay the initial window based on the note display area having a higher user interface privilege than the initial window.

37. The device of claim 36, further comprising:
means for stopping the displaying of the note display area and the one or more action identifiers of the note-taking application in response to the performing of the action; and
means for returning to the displaying of the initial window after the stopping.

38. The device of claim 34, further comprising:
means for receiving a registration of an action corresponding to an identified pattern for an application on the device;
means for determining a pattern in at least a part of the information;
means for determining if the pattern matches the identified pattern corresponding to the registration; and
means for changing, based on determining the pattern matches the identified pattern, the displaying of the one or more action identifiers to include a pattern-matched action identifier different from the one or more action identifiers.

39. The device of claim 34, wherein the means for displaying, in response to the trigger event, further comprises means for displaying a virtual keypad and one or more virtual action keys defining the one or more action identifiers, and wherein the means for receiving the input of the information further comprises means for receiving at the virtual keypad.

40. The device of claim 34, further comprising means for stopping the displaying of the note display area and the one or more action identifiers of the note-taking application in response to the performing of the action.

41. The device of claim 34, further comprising means for displaying a confirmation message in response to completing the performing of the action.

42. The device of claim 34, wherein the trigger event comprises at least one of a user-input at a key, or the user-input at a microphone, or the user-input at a touch-sensitive display, or the user-input at a motion sensor.

43. The device of claim 34, wherein the input of the information includes at least one of text information, voice information, audio information, geographic position or movement information, video information, graphic information, or photograph information.

44. The device of claim 34, wherein the means for displaying of the information further comprises means for displaying a representation of two or more types of different information.

45. A computer device, comprising:
a memory comprising a note-taking application for capturing user-entered information, wherein the note-taking application;
a processor configured to execute the note-taking application;
an input mechanism configured to receive a trigger event to invoke a note-taking application;
a display configured to display, in response to the trigger event, a note display area and one or more action identifiers of the note-taking application on at least a portion of an output display on the device;
wherein the input mechanism is further configured to receive an input of information;
wherein the display is further configured to display the information in the note display area in response to the input;
wherein the input mechanism is further configured to receive identification of a selected one of the one or more action identifiers after receiving the input of the information, wherein each of the one or more action identifiers corresponds to a respective action to take with the information; and
wherein the note-taking application initiates performing an action on the information based on the selected action identifier.

46. The computer device of claim 45, wherein each of the one or more action identifiers corresponds to a respective function of one or more of a plurality of applications on the device, and wherein the note-taking application initiates performing the action by initiating execution of the one of the plurality of applications corresponding to the selected action identifier to perform the respective function.

47. The computer device of claim 45, further comprising:
wherein the display is further configured to display an initial window corresponding to execution of one of a plurality of applications on the device;
wherein the receiving of the trigger event occurs during the initial window and execution of the one of the plurality of applications; and
wherein the display presents the note display area and the one or more action identifiers to at least partially overlay the initial window based on the note display area having a higher user interface privilege than the initial window.

48. The computer device of claim 47, wherein the note-taking application is further configured to stop the displaying of the note display area and the one or more action identifiers of the note-taking application in response to the performing of the action, and to return the display to the displaying of the initial window.

49. The computer device of claim 45, further comprising:
an action registry configured to receive a registration of an action corresponding to an identified pattern for an application on the device;
a pattern detector configured to determine a pattern in at least a part of the information, and to determine if the pattern matches the identified pattern corresponding to the registration; and
an action option changer configured to change, based on determining the pattern matches the identified pattern, the displaying of the one or more action identifiers to include a pattern-matched action identifier different from the one or more action identifiers.

50. The computer device of claim 45, wherein the display is further configured to display, in response to the trigger event, a virtual keypad and one or more virtual action keys defining the one or more action identifiers, and wherein the input mechanism is further configured to receive the input of the information at the virtual keypad.

51. The computer device of claim 45, wherein the note-taking application is further configured to stop the displaying of the note display area and the one or more action identifiers of the note-taking application in response to the performing of the action.

52. The computer device of claim 45, wherein the note-taking application is further configured to cause the display to present a confirmation message in response to completing the performing of the action.

53. The computer device of claim 45, wherein the trigger event comprises at least one of a user-input at a key, or the user-input at a microphone, or the user-input at a touch-sensitive display, or the user-input at a motion sensor.

54. The computer device of claim 45, wherein the input of the information includes at least one of text information, voice information, audio information, geographic position or movement information, video information, graphic information, or photograph information.

55. The computer device of claim 45, wherein the note-taking application is further configured to cause the display to present the information to include a representation of two or more types of different information.
